(19) United States
(12) Patent Application Publication
(10) Pub. No.: US 2026/0238804 A1
(43) Pub. Date: Aug. 13, 2026

(54) MULTIPLE PERSPECTIVE VIDEO STREAMING USING GRADUAL DECODING REFRESH

(71) Applicant: DOLBY LABORATORIES LICENSING CORPORATION

(72) Inventors: Guan-Ming Su, Fremont, CA (US); Sheng Qu, San Jose, CA (US); Peng Yin, Ithaca, NY (US); Samir Hulyalkar, Los Gatos, CA (US)

(73) Assignee: DOLBY LABORATORIES LICENSING CORPORATION, (US)

(21) Appl. No.: 19/530,040

(22) Filed: Feb. 4, 2026

Related U.S. Application Data
(60) Provisional application No. 63/756,492, filed on Feb. 10, 2025.

(30) Foreign Application Priority Data
Mar. 5, 2025 (EP) 25161935.9

(51) Int. Cl. H04N 19/196; H04N 19/159; H04N 19/172; H04N 19/66

(52) U.S. Cl. CPC H04N 19/196; H04N 19/159; H04N 19/172; H04N 19/66

(57) ABSTRACT

In one example, a method of streaming a multiple perspective video of a scene includes generating two or more streams of decoding units (DUs) to encode the videos of different respective views of the scene by intra-coding a selected region of a respective frame, inter-coding other regions of the respective frame, and changing the selected region in accordance with a gradual decoding refresh period. The method also includes generating a stream of packets to carry the generated streams of DUs. The stream of packets includes source packets and parity packets configured to provide unequal error protection to different sets of the DUs based on the respective importance ranks assigned thereto. In some examples, the unequal error protection is implemented using rateless forward error correction coding and a greedy algorithm for optimally distributing the budget of parity packets among the various DUs.

### 1. CROSS-REFERENCE TO RELATED APPLICATIONS

This patent application claims the benefit of priority from U.S. Provisional patent application Ser. No. 63/756,492, filed on 10 Feb. 2025, and European patent application 25161935.9, filed on 5 Mar. 2025, each incorporated by reference in its entirety.

### 2. FIELD OF THE DISCLOSURE

Various example embodiments relate to video streaming and, more specifically but not exclusively, to streaming of multiple perspective audio and video (MPAV) using gradual decoding refresh.

### 3. BACKGROUND

Ultra-low latency is a desired attribute of at least some contemporary and/or emerging communications networks. For example, ultra-low latency may be needed for real time reactions in certain remote-operated machines. However, it is not only the network connection but also the corresponding codec that needs to operate with sufficiently low delay to adequately support real-time responsive applications.

Versatile Video Coding (VVC, also known as H.266, ISO/IEC 23090-3, and MPEG-I Part 3) is an example of a video standard in which video codecs support gradual decoding refresh (GDR). The GDR feature may be beneficial in real-time responsive applications because it may reduce the end-to-end delay that is otherwise experienced with some video codecs, e.g., from about a quarter of a second down to a few tens of a millisecond, by matching the encoded video bitrate with the network throughput. This delay reduction typically produces a significant improvement in the quality of user experience. For example, in a multiparty video conference, the lower delay makes it far less likely for the participants to talk over each other.

### BRIEF SUMMARY OF SOME SPECIFIC EMBODIMENTS

Disclosed herein are various embodiments of a low-delay, error-resilient system for streaming multiple perspective audio and video (MPAV). To provide the low-delay characteristic, the system uses a gradual decoding refresh (GDR)-capable video codec adapted for MPAV-streaming purposes. To provide the error resiliency, the system is configured to use an unequal error protection (UEP) scheme and one or more greedy algorithms directed at nearly optimally distributing the dynamically variable available budget of parity packets among the MPAV decoding units (DUs) to maintain the picture quality near an expected optimal quality level. Some embodiments also incorporate an error-concealment mechanism configured to use a downsampled version of the pertinent video frame to beneficially mitigate the adverse effects of lost or undecodable DUs on the overall video quality of the MPAV rendered by the video player.

According to one example, a method of streaming a multiple perspective video of a scene comprises: generating a first stream of decoding units (DUs) to encode a video of a first view of the scene by intra-coding a selected region of a respective frame, inter-coding other regions of the respective frame, and changing the selected region based on a first gradual decoding refresh (GDR) period; generating a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view; and generating a stream of packets to carry the first and second streams of DUs, the stream of packets including a stream of source packets and a stream of parity packets configured to provide unequal error protection to different sets of the DUs.

According to another example, a method of streaming a multiple perspective video of a scene comprises: receiving a stream of packets configured to carry a first stream of decoding units (DUs) and a second stream of DUs, the stream of packets including a stream of source packets and a stream of parity packets configured to provide unequal error protection to different sets of the DUs, the first stream of DUs encoding a video of a first view of the scene and having been generated by intra-coding a selected region of a respective frame, inter-coding other regions of the respective frame, and changing the selected region based on a first gradual decoding refresh (GDR) period, the second stream of DUs encoding a video of a second view of the scene and having been generated by intra-coding a chosen region of a corresponding frame, inter-coding other regions of the corresponding frame, and changing the chosen region based on a second GDR period, the video of the second view having a lower spatial resolution and a lower bit rate than the video of the first view; reconstructing the first stream of DUs and the second stream of DUs based on the stream of source packets and the stream of parity packets; and playing at least one of the video of the first view and the video of the second view on a player device using GDR and further using at least one of the reconstructed first and second streams of DUs.

Some examples provide a non-transitory computer-readable medium storing instructions that, when executed by an electronic processor, cause the electronic processor to perform operations comprising the any one of the above methods.

According to yet another example, an apparatus for streaming a multiple perspective video of a scene comprises: at least one processor; and at least one memory including program code, wherein the at least one memory and the program code are configured to, with the at least one processor, cause the apparatus at least to: generate a first stream of decoding units (DUs) to encode a video of a first view of the scene by intra-coding a selected region of a respective frame, inter-coding other regions of the respective frame, and changing the selected region based on a first gradual decoding refresh (GDR) period; generate a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view; and generate a stream of packets to carry the first and second streams of DUs, the stream of packets including a stream of source packets and a stream of parity packets configured to provide unequal error protection to different sets of the DUs.

According to yet another example, an apparatus for streaming a multiple perspective video of a scene comprises: at least one processor; and at least one memory including program code, wherein the at least one memory and the program code are configured to, with the at least one processor, cause the apparatus at least to: receive a stream of packets configured to carry a first stream of decoding units (DUs) and a second stream of DUs, the stream of packets including a stream of source packets and a stream of parity packets configured to provide unequal error protection to different sets of the DUs, the first stream of DUs encoding a video of a first view of the scene and having been generated by intra-coding a selected region of a respective frame, inter-coding other regions of the respective frame, and changing the selected region based on a first gradual decoding refresh (GDR) period, the second stream of DUs encoding a video of a second view of the scene and having been generated by intra-coding a chosen region of a corresponding frame, inter-coding other regions of the corresponding frame, and changing the chosen region based on a second GDR period, the video of the second view having a lower spatial resolution and a lower bit rate than the video of the first view; reconstruct the first stream of DUs and the second stream of DUs based on the stream of source packets and the stream of parity packets; and play at least one of the video of the first view and the video of the second view on a player device using GDR and further using at least one of the reconstructed first and second streams of DUs.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating a video/audio/image delivery pipeline according to some examples.

FIG. 2 is a block diagram illustrating a configuration for capturing MPAV content that can be used in the pipeline of FIG. 1 according to some examples.

FIG. 3 is a schematic diagram illustrating a video sequence including an instantaneous decoding refresh frame, a clean random-access frame, and inter-predicted frames according to some examples.

FIGS. 4A-4B graphically illustrate the qualitative time dependence of the bit count per picture and peak signal-to-noise ratio (PSNR) for the video sequence illustrated in FIG. 3 according to some examples.

FIG. 5 schematically illustrates the concept of gradual decoding refresh (GDR) according to some examples.

FIG. 6 schematically illustrates a picture partitioned into slices and segments according to some examples.

FIGS. 7A-7B schematically illustrate a picture partitioned into tiles and slices according to some examples.

FIG. 8 is a schematic diagram illustrating two configurations of GDR according to some examples.

FIGS. 9A-9B graphically illustrate qualitative improvements in the time dynamics of the bit count per picture and PSNR achieved with GDR according to some examples.

FIG. 10 shows a table illustrating decoder support for different types of random access according to some examples.

FIG. 11 is a block diagram illustrating a network abstraction layer (NAL) unit stream according to some examples.

FIG. 12 is a block diagram illustrating a configuration for capturing MPAV content that can be used in the pipeline of FIG. 1 according to some additional examples.

FIG. 13 is a block diagram illustrating the camera views of the MPAV configuration of FIG. 12 sorted into main, side, and rare views according to some examples.

FIG. 14 is a block diagram illustrating a use of GDR in multiple perspective video according to some examples.

FIG. 15 is a block diagram illustrating an unequal error protection (UEP) scheme that can be applied to the multiple perspective video illustrated in FIG. 14, according to some examples.

FIG. 16 is a block diagram illustrating temporal domain quality consistency constraints being used to implement the UEP scheme of FIG. 15 according to some examples.

FIG. 17 is a schematic diagram illustrating two configurations of GDR according to some additional examples.

FIG. 18 is a block diagram of an example computing device configured to perform at least some operations of methods, algorithms, and procedures described herein according to some examples.

FIG. 19 is a flowchart illustrating a method of streaming a multiple perspective video according to some examples.

FIG. 20 is a flowchart illustrating another method of streaming a multiple perspective video according to some examples.

### DETAILED DESCRIPTION

Various embodiments disclosed herein are directed at providing a playback mode for streaming MPAV content. In at least some examples, MPAV streaming can beneficially be used to provide immersive experience for end users from multiple perspectives/viewing angles within the same event. For example, the pertinent MPAV footage can be stored in a bitstream with metadata to allow for synchronized playback between different perspectives. To provide ultra-low delay MPAV communications, example embodiments leverage at least some features of gradual decoding refresh (GDR). To alleviate the impact from and provide relatively high resiliency to streaming over error prone channels, at least some embodiments may apply unequal error protection (UEP) for different video/data units, e.g., according to the relative importance of each particular video/data unit and/or the relative importance of the corresponding view.

### Example Video/Audio/Image Delivery Pipeline

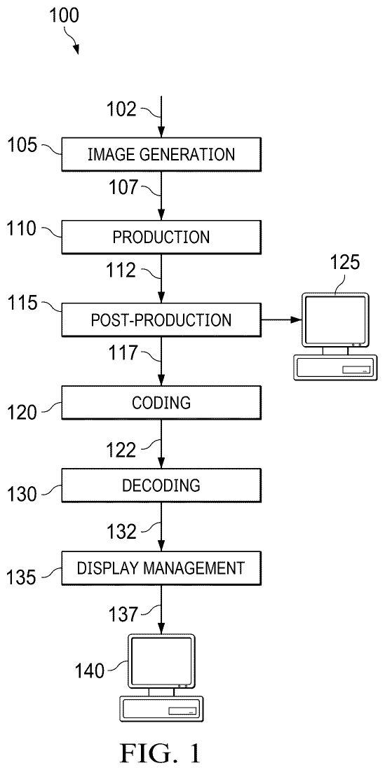

FIG. 1 is a block diagram illustrating an example process of a video/audio/image delivery pipeline (100), showing various stages from video/audio/image capture to content display according to some examples. A sequence of images (102) may be captured or generated using an image-generation block (105). The images (102) may be digitally captured (e.g., by a digital camera) or generated by a computer (e.g., using computer animation) to provide corresponding video, audio, and/or image data (107). Alternatively, the images (102) may be captured on film by a film camera. Then, the film may be translated into a digital format to provide the video/audio/image data (107).

In a production phase (110), the data (107) may be edited to provide a video/audio/image production stream (112). The data of the video/audio/image production stream (112) may be provided to a processor (or one or more processors, such as a central processing unit, CPU) at a post-production block (115) for post-production editing. The post-production editing of the block (115) may include, e.g., adjusting or modifying colors or brightness in particular areas of an image to enhance the image quality or achieve a particular appearance for the image in accordance with the video creator's creative intent. This part of post-production editing is sometimes referred to as “color timing” or “color grading.” Other editing (e.g., scene selection and sequencing, image cropping, addition of computer-generated visual special effects, removal of artifacts, etc.) may be performed at the block (115) to yield a “final” version (117) of the production for distribution. During the post-production editing (115), video and/or images may be viewed on a reference display (125).

Following the post-production (115), the data of the final version (117) may be delivered to a coding block (120) for being further delivered downstream to decoding and playback devices, such as television sets, set-top boxes, movie theaters, and the like. In some embodiments, the coding block (120) may include audio and video encoders, such as those defined by the ATSC, DVB, DVD, Blu-Ray, and other delivery formats, to generate a coded bitstream (122). In a receiver, the coded bitstream (122) is decoded in a decoding block (130) to generate a corresponding decoded signal (132) representing a copy or a close approximation of the signal (117). The receiver may be attached to a target display (140) that may have somewhat or completely different characteristics than the reference display (125). In such cases, a display management (DM) block (135) may be used to map the decoded signal (132) to the characteristics of the target display (140) by generating a display-mapped signal (137). Depending on the embodiment, the decoding block (130) and the display management block (135) may include individual processors or may be based on a single integrated processing unit.

A codec used in the coding block (120) and/or the decoding block (130) enables video/audio/image data processing and compression/decompression. The compression is used in the coding block (120) to make the corresponding file(s) or stream(s) smaller. The decoding process carried out in the decoding block (130) typically includes decompressing the received video/audio/image data file(s) or streams(s) into a form usable for playback and/or further editing. Example coding/decoding operations that can be used in the coding block (120) and the decoding unit (130) according to various embodiments are described in more details below.

The success of streaming video has generated interest in newer forms of video content, such as the video/audio content generated with 360-degree cameras, multi-angle camera arrays, and/or light-field cameras. The immersive experience enabled by these cameras can enhance user satisfaction for broadcast performances (e.g., theater and concerts) and events (e.g., graduation and award ceremonies), as well as online meetings. With the MPAV capture, users do not just passively consume content, but may interactively traverse the content along many different paths from a perspective of their choice, with different users being able to observe different perspectives of the same content. To support MPAV applications at Internet scale, the client player devices are expected to download, and the content distribution networks (CDNs) are expected to generate perspectives on demand while ensuring low latency and support for a variety of devices for capture and consumption of the corresponding MPAV content.

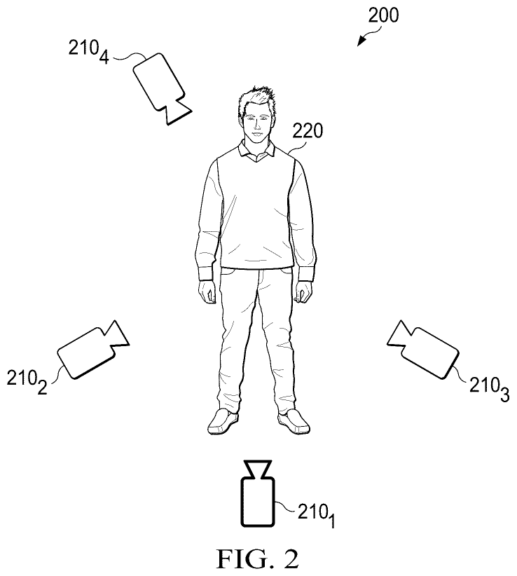

FIG. 2 is a block diagram illustrating a configuration (200) for capturing MPAV content that can be used in the pipeline (100) according to some examples. In some cases, the configuration (200) can be used in the production phase (110) of the delivery pipeline (100). In the example shown, the configuration (200) includes video/audio capture devices (210₁-210₄), such as cameras. Each of the video/audio capture devices (210₁-210₄) is oriented at a different respective angle with respect to a scene (220) that is being captured.

An example MPAV communication system is configured to provide multiple views captured at the same event with synchronized videos. In this service, multiple bitstreams may be sent from the server to an end user. Depending on individual preferences, the users may choose to watch only some (e.g., one or more) or all of the transmitted views. The user may also switch views during the playback time.

One of technical challenges associated random access is that random access comes at the expense of compression efficiency, e.g., because it does not sufficiently exploit the temporal correlation between the frames in a video sequence. Uncompressed video is composed of still images that follow each other. In one second of video, there are typically about 24 to 60 frames. One simple form of random access is achieved through a special type of frame referred to as the instantaneous decoding refresh (IDR) frame. The IDR frame is independent from any other frame and is not typically followed by frames that depend on any frame preceding the IDR frame.

A clean random access (CRA) frame enables a more sophisticated form of random access. Although a CRA frame is also independent from any other frames, but unlike an IDR frame, a CRA frame may be followed by frames that precede the CRA frame in the display order and depend on one or more frames preceding the CRA frame. This property of CRA frames can be used to improve the compression efficiency and ensure consistent picture quality between different frames.

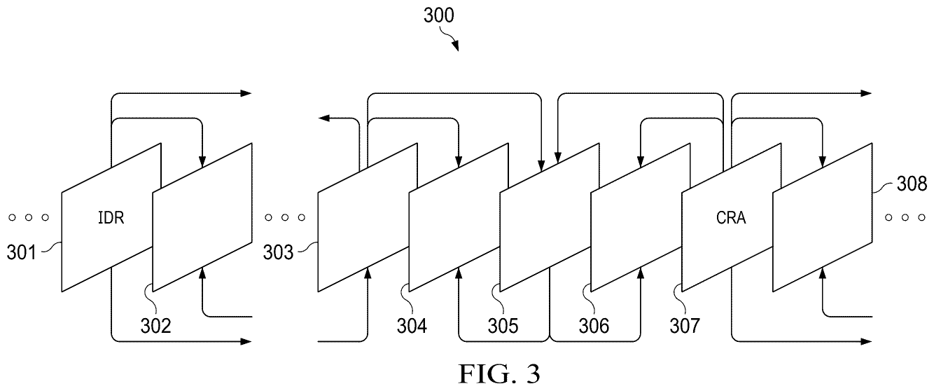

FIG. 3 is a schematic diagram illustrating a video sequence (300) including an IDR frame (301), a CRA frame (307), and inter-predicted frames (302-306, 308) according to some examples. The arrows schematically illustrate inter-frame prediction used for the inter-predicted frames (302-306, 308). Inter-prediction means that each of the inter-predicted frames (302-306, 308) is divided into blocks which are then encoded by pointing to approximately matching blocks in the reference frames (301, 307). In the example illustrated in FIG. 3, the prediction arrows originate from the reference frames (301, 307) and point to the corresponding ones of the inter-predicted frames (302-306, 308).

An individual user's experience of network throughput may vary due to many reasons, one of which may be the total volume of the network traffic. When the video bitrate exceeds the network throughput, the receiver does not have enough bandwidth for real-time playback and therefore is required to pause playback for rebuffering. Avoiding these kinds of interruptions may require adapting the streamed video bitrate to make sure that it does not exceed the current network throughput. In some cases, the same video content is encoded multiple times and made available as multiple versions that have different resolutions and bitrates, and the playback device can select which version to stream on a segment-by-segment basis. Each segment starts with an IDR or CRA frame (e.g., 301 or 307) so that the segment can be properly decoded.

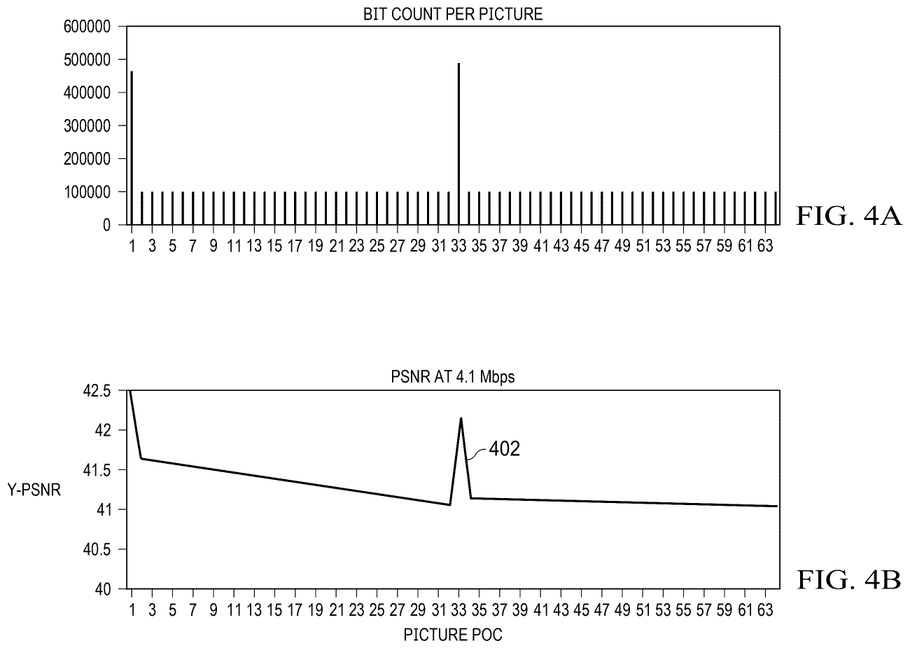

FIGS. 4A-4B graphically illustrate the approximate time dependence of the bit count per picture and peak signal-to-noise ratio (PSNR) for the video sequence (300) according to some examples. Note that the time axis used in FIGS. 4A-4B has the units of picture order count (POC). The graph shown in FIG. 4A illustrates that the IDR/CRA-based solutions exhibit a significantly higher bit count at the time of the intra refresh frame (e.g., 301 or 307). Undesired consequences of the higher bit count (or larger packet size) may include: (i) a longer delay at the receiver to start the decoding; (ii) a higher probability to lose the corresponding packet; and (iii) a sudden picture quality jump, which might cause viewing discomfort. A curve (402) shown in FIG. 4B graphically illustrates such quality jumps around the time of the intra refresh frame (e.g., 301 or 307), as quantified by the observed PSNR values.

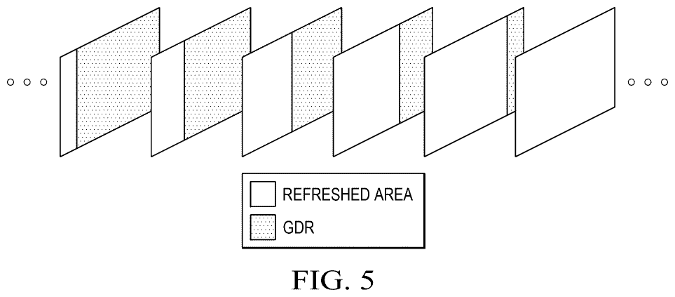

FIG. 5 schematically illustrates the concept of gradual decoding refresh (GDR) according to some examples. In GDR, the content of the frame is refreshed over a number of frames, e.g., as depicted in FIG. 5. As a result, only a relatively small portion of the GDR frame is compressed without inter-frame prediction, and thus that portion can be recovered correctly when the decoding starts from that GDR frame. In subsequent frames, the refreshed area can either be compressed without inter-frame prediction or only use the refreshed areas in the previous frames for prediction. In at least some examples, GDR may beneficially help to avoid temporal bitrate and PSNR fluctuations illustrated in FIGS. 4A-4B. As a result, GDR can beneficially be leveraged, e.g., as described in more detail below, to achieve ultra-low latency for MPAV streaming applications.

From the communication system's point of view, achieving low delay means the adoption of UEP (unequal error protection) instead of TCP (Transmission Control Protocol) in at least some examples. However, the adaptation of the UEP may face a major packet loss especially when used for error-prone channels. To improve the error resiliency while preserving low delay, forward error coding (FEC) can be used. Knowing the priority and importance of different portions (views/video units) in this MPAV bitstream, one can deploy UEP to protect different portions of the bitstream(s) in accordance with the current network bandwidth and packet loss rate. Accordingly, various embodiments disclosed herein provide a novel communication framework that incorporates certain aspects of GDR and FEC to handle MPAV bitstream, thereby providing ultra-low delay and nearly optimal final rendered video quality for streaming via an error-prone communication channel.

### Example Implementation of Gradual Decoding Refresh (GDR)

An access unit (AU) is defined in the High Efficiency Video Coding (HEVC) specification as follows:

access unit: A set of NAL units that are associated with each other according to a specified classification rule, are consecutive in decoding order, and contain exactly one coded picture with nuh_layer_id equal to 0.
NOTE 1-In addition to containing the VCL NAL units of the coded picture with nuh_layer_id equal to 0, an access unit may also contain non-VCL NAL units. The decoding of an access unit with the decoding process always results in a decoded picture with nuh_layer_id equal to 0.
NOTE 2—An access unit is defined differently in Annex and does not need to contain a coded picture with nuh_layer_id equal to 0.

In some examples, an AU is a picture/frame. To start the decoding process for one AU, the decoder needs to wait until all bits belonging to the same AU have arrived. This wait may disadvantageously cause a relatively long delay when the AU has a relatively large size (number of bits). To address this issue, a decoding unit (DU) is used in some embodiments. In one example, a DU can be defined as follows:
decoding unit: An access unit if SubPicHrdFlag is equal to 0 or a subset of an access unit otherwise, consisting of one or more VCL NAL units in an access unit and the associated non-VCL NAL units.

To utilize a DU in practice, one can partition a picture into multiple slices. Each slice is placed into a corresponding (one) DU and packed as one NAL (Network Abstraction Layer). By doing so, the decoding process can start once the decoder receives one DU, which can beneficially shorten the delay versus the delay incurred for a corresponding AU. With the additional level of granularity corresponding to the DU, the end-to-end delay corresponding to larger frames (e.g., 301 or 307) can be shortened accordingly. The signaling for each DU and the corresponding DU index is defined in a “decoding_unit_info” supplemental enhancement information (SEI) message, which is defined and described in one of the following sections of this specification.

In one example, a slice and a tile are defined as follows:
slice: An integer number of coding tree units contained in one independent slice segment and all subsequent dependent slice segments (if any) that precede the next independent slice segment (if any) within the same access unit.
slice header: The slice segment header of the independent slice segment that is a current slice segment or the most recent independent slice segment that precedes a current dependent slice segment in decoding order.
slice segment: An integer number of coding tree units ordered consecutively in the tile scan and contained in a single NAL unit.
slice segment header: A part of a coded slice segment containing the data elements pertaining to the first or all coding tree units represented in the slice segment.

Using the above definitions, we now describe examples of partitioning of pictures into slices, slice segments, and tiles. In some examples, pictures are divided into slices and tiles. A slice is a sequence of one or more slice segments starting with an independent slice segment and containing all subsequent dependent slice segments (if any) that precede the next independent slice segment (if any) within the same picture. A slice segment is a sequence of coding tree units (CTUs). Likewise, a tile is a sequence of CTUs.

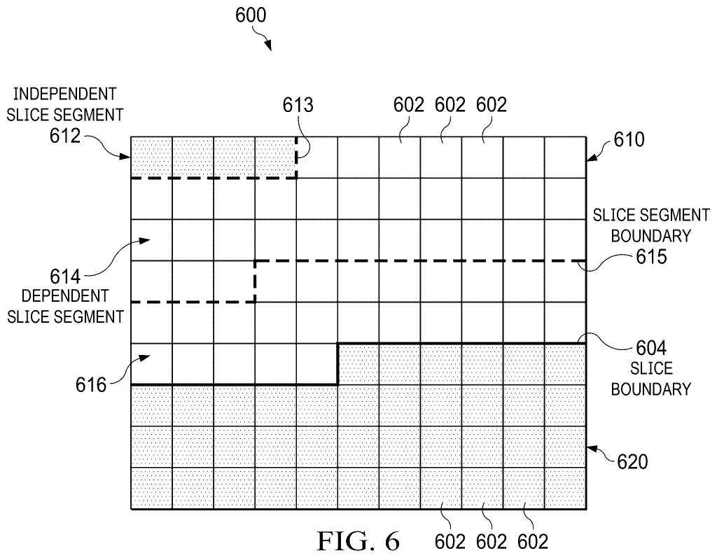

FIG. 6 schematically illustrates a picture (600) partitioned into slices and segments according to some examples. In the illustrated example, the picture (600) comprises 11×9 luma CTUs (602). The picture (600) is partitioned into first and second slices (610, 620) using a slice boundary (604). The first slice (610) is partitioned into first, second, and third slice segments (612, 614, 616). The first slice segment (612) is an independent slice segment containing four CTUs (602). The second slice segment (614) is a dependent slice segment containing thirty-two CTUs (602). The third slice segment (616) is another dependent slice segment containing twenty-four CTUs (602). A slice segment boundary (613) is the boundary between the first and second slice segments (612, 614). A slice segment boundary (615) is the boundary between the second and third slice segments (614, 616). The second slice (620) has a single independent slice segment containing the remaining thirty-nine CTUs (602) of the picture (600).

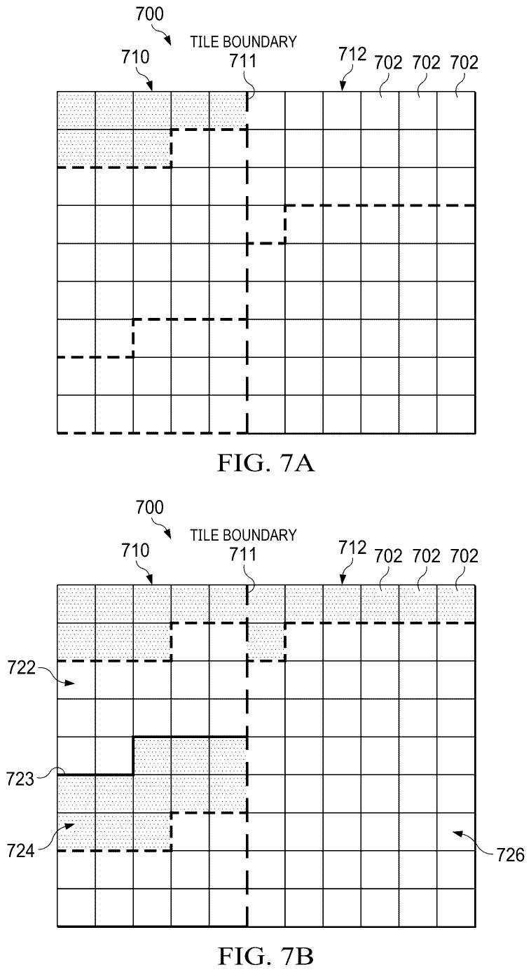

FIGS. 7A-7B schematically illustrate a picture (700) partitioned into tiles and slices according to some examples. In the illustrated examples, the picture (700) comprises 11×9 luma CTUs (702). In both shown examples, the picture (700) is partitioned into first and second tiles (710, 712) using a tile boundary 711. In the example shown in FIG. 7A, the picture (700) contains a single slice encompassing the whole picture. In the example shown in FIG. 7B, the picture (700) contains a total of three slices (722, 724, 726). The first tile (710) has the first and second slices (722, 724) with a slice boundary (723) therebetween. The second tile (712) has a single slice (726). Each of the slices (722, 724, 726) has two respective slice segments, including one respective independent slice segment and one respective dependent slice segment.

Unlike slices, tiles are rectangular. A tile always contains an integer number of CTUs and may have some CTUs contained in more than one slice. Similarly, a slice may have CTUs contained in more than one tile. One or both of the following conditions is/are fulfilled for each slice and tile:
(1) All CTUs in a slice belong to the same tile.
(2) All CTUs in a tile belong to the same slice.
NOTE: Within the same picture, there may be both the slices that contain multiple tiles and the tiles that contain multiple slices.

When a picture is coded using three separate color planes (separate_colour_plane_flag is equal to 1), a slice contains only CTUs of the color component identified by the corresponding value of colour plane_id, and each color component array of a picture has slices having the same colour_plane_id value. Coded slices with different values of colour_plane_id within a picture may be interleaved with each other under the constraint that for each value of colour plane_id, the coded slice segment NAL units with that value of colour plane_id are in the order of increasing CTU address in the tile scan order for the first CTU of each coded slice segment NAL unit.
NOTE: When separate_colour plane_flag is equal to 0, each CTU of a picture is contained in exactly one slice. When separate_colour_plane_flag is equal to 1, each CTU of a color component is contained in exactly one slice (i.e., information for each CTU of a picture is present in exactly three slices and these three slices have different values of colour_plane_id).

As illustrated in FIGS. 7A-7B, a slice can contain multiple tiles, and a tile can contain multiple slices. Also note that only a slice can be placed into a NAL unit.

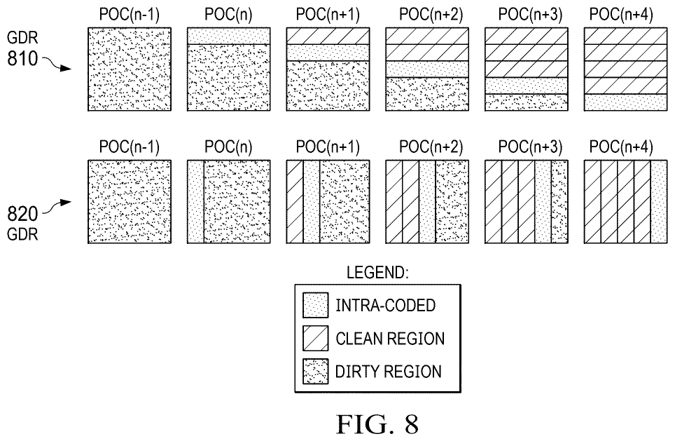

FIG. 8 is a schematic diagram illustrating two configurations (810, 820) of GDR according to some examples. A basic idea is to partition the picture into multiple regions and configure the encoder to encode one region of the picture using an intra-coded mode while encoding other regions of the picture using an inter-coded mode for each image. The encoder can gradually change the region to which the intra-coded mode is applied along the time domain such that each region can be refreshed using the intra-coded information. Example terminology typically used in GDR-related texts includes the following terms:
GDR period: a group of frames implementing GDR. In the example configurations (810, 820) illustrated in FIG. 8, a GDR period is from POC (n) to POC (n+N−1), where N=5. In other examples, other N values can also be used.
GDR picture: the first picture within a GDR period is referred to as the GDR picture. In each of the example configurations (810, 820) illustrated in FIG. 8, the respective GDR picture is at POC (n).
Recovery point picture: The forced intra-coded areas gradually spread over the N pictures of the GDR period. The last picture at POC (n+N−1) is completly intra refreshed. This picture is referred to as the recovery point picture.
Recovering pictures: Pictures at POC (n+1), . . . ,POC (n+N−2) are referred to as recovering pictures of the GDR picture at POC (n).

A typical picture within a GDR period contains a clean (or refreshed) area and a dirty (or non-refreshed) area (also see the legend shown in FIG. 8). The clean area may contain a forced intra area located next to the dirty area, e.g., as illustrated in FIG. 8.

In some cases, GDR requires “exact match” at recovery points. With the exact match, the reconstructed pictures at the recovery points of the encoder and decoder should be identical (or matched). To achieve the exact match, coding units (CUs) in clean areas should not use any coding information (e.g., reconstructed pixels, code mode, motion vector (MV), reference picture index (refIdx), reference picture list (refList), etc.) from dirty areas because the coding information in the dirty areas may not be correctly decoded at the decoder. The incorrectly decoded information from the dirty areas may contaminate the clean areas, which will likely result in a mismatch of the encoder and decoder at the recovery points (or leaks).

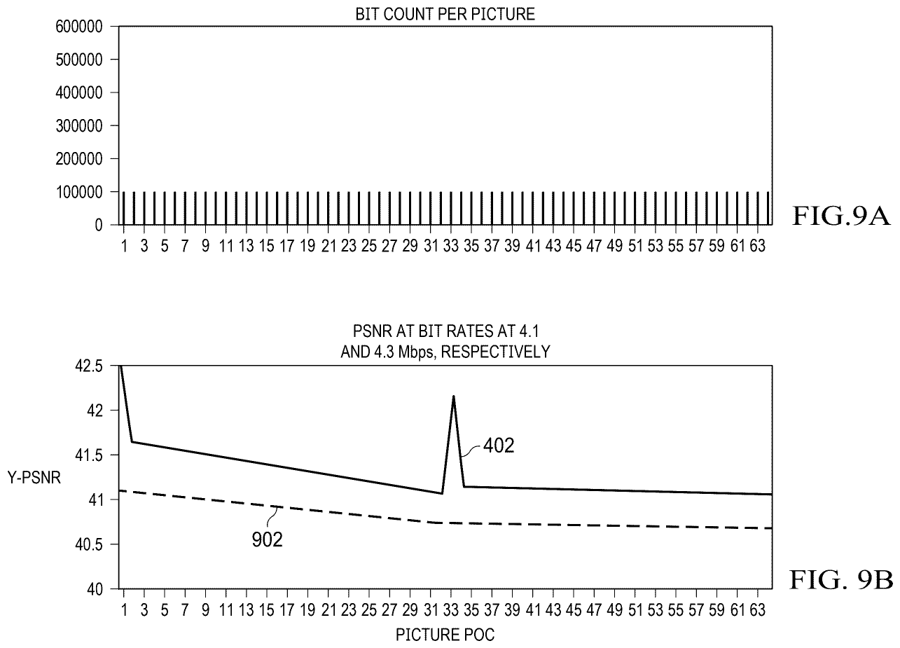

FIGS. 9A-9B graphically illustrate qualitative improvements in the time dynamics of the bit count per picture and PSNR achieved with GDR according to some examples. For better understanding of the improvements, FIGS. 9A-9B should be compared with FIGS. 4A-4B. Comparison of FIGS. 4A and 9A illustrates that the bit count per picture is smoother with GDR because the intra-coded portions are spread over multiple frames. FIG. 9B provides a comparison of the curve (402) (previously shown in FIG. 4B) with a curve (902) illustrating the GDR performance under similar conditions, which indicates a beneficially smoother PSNR dynamics for the latter.

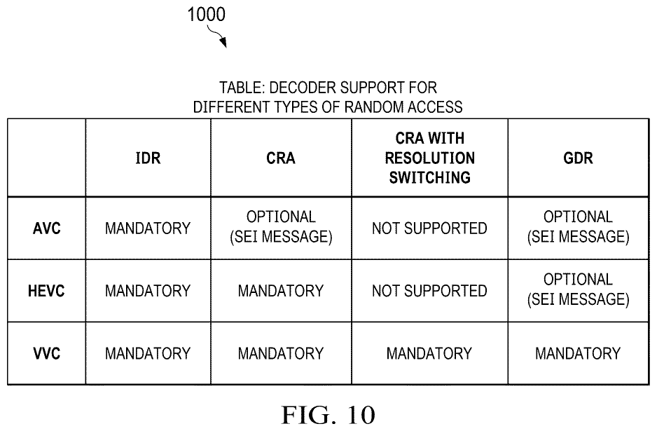

FIG. 10 shows a table (1000) illustrating decoder support for different types of random access according to some examples. In general, video coding standards specify some features as mandatory, meaning that all standard-conforming decoders must implement those features. Some other features may be specified as optional, meaning that the encoders may indicate those features in the bitstream, but the corresponding decoders are not required to support them. The table (1000) presents a brief summary of how different above-described random-access types are specified as mandatory or optional in several video coding standards. Unlike the VVC standard which includes GDR in its Video Coding Layer (VCL), the HEVC and Advanced Video Coding (AVC) standards specify GDR as being optional. Accordingly, SEI messages need to be used to enable GDR in HEVC- and AVC-conforming decoders. Thus, examples of such SEI messages pertinent to the present disclosure are provided below. For illustration purposes and without any implied limitations, the provided examples refer to the HEVC standard (Recommendation ITU-T H.265 (V10) (07/2024), “High efficiency video coding”), which is incorporated herein by reference in its entirety.

Pic_timing SEI:

| | Descriptor |
|---|---|
| pic_timing( payloadSize ) { | |
| if( frame_field_info_present_flag ) { | |
| pic_struct | u(4) |
| source_scan_type | u(2) |
| duplicate_flag | u(1) |
| } | |
| if( CpbDpbDelaysPresentFlag ) { | |
| au_cpb_removal_delay_minus1 | u(v) |
| pic_dpb_output_delay | u(v) |
| if( sub_pic_hrd_params_present_flag ) | |
| pic_dpb_output_du_delay | u(v) |
| if( sub_pic_hrd_params_present_flag && | |
| sub_pic_cpb_params_in_pic_timing_sei_flag ) { | |
| num_decoding_units_minus1 | ue(v) |
| du_common_cpb_removal_delay_flag | u(1) |
| if( du_common_cpb_removal_delay_flag ) | |
| du_common_cpb_removal_delay_increment_minus1 | u(v) |
| for( i = 0; i <= num_decoding_units_minus1; i++ ) { | |
| num_nalus_in_du_minus1[ i ] | ue(v) |
| if( !du_common_cpb_removal_delay_flag && i < | |
| num_decoding_units_minus1 ) | |
| du_cpb_removal_delay_increment_minus1[ i ] | u(v) |
| } | |
| } | |
| } | |
| } | |

num_decoding_units_minus1 plus 1 specifies the number of decoding units in the access unit the picture timing SEI message is associated with. The value of num_decoding_units_minus1 shall be in the range of 0 to PicSizeInCtbsY-1, inclusive.
num_nalus_in_du_minus1[i] plus 1 specifies the number of NAL units in the i-th decoding unit of the access unit the picture timing SEI message is associated with. The value of num_nalus_in_du_minus1[i] shall be in the range of 0 to PicSizeInCtbsY-1, inclusive.

The first decoding unit of the access unit comprises the first num_nalus_in_du minus1 [0]+1 consecutive NAL units in decoding order in the access unit. The i-th (with i greater than 0) decoding unit of the access unit consists of the num_nalus_in_du_minus1[i]+1 consecutive NAL units immediately following the last NAL unit in the previous decoding unit of the access unit, in decoding order. There shall be at least one VCL NAL unit in each decoding unit. All non-VCL NAL units associated with a VCL NAL unit shall be included in the same decoding unit as the VCL NAL unit.

Decoding_unit_info SEI:

| | Descriptor |
|---|---|
| decoding_unit_info( payloadSize ) { | |
| decoding_unit_idx | ue(v) |
| if( !sub_pic_cpb_params_in_pic_timing_sei_flag ) | |
| du_spt_cpb_removal_delay_increment | u(v) |
| dpb_output_du_delay_present_flag | u(1) |
| if( dpb_output_du_delay_present_flag ) | |
| pic_spt_dpb_output_du_delay | u(v) |
| } | |

The decoding unit information SEI message provides CPB removal delay information for the decoding unit associated with the SEI message.

When the buffering period SEI message is non-nested or is directly contained in a scalable nesting SEI message within an SEI NAL unit with nuh_layer_id equal to 0, the following applies for the decoding unit information SEI message syntax and semantics:
The syntax elements sub_pic_hrd_params_present_flag, sub_pic_cpb_params_in_pic_timing_sei_flag, and dpb_output_delay_du_length_minus1, and the variable CpbDpbDelaysPresentFlag are found in or derived from syntax elements in the hrd_parameters ( ) syntax structure that is applicable to at least one of the operation points to which the decoding unit information SEI message applies.
The bitstream (or a part thereof) refers to the bitstream subset (or a part thereof) associated with any of the operation points to which the decoding unit information SEI message applies.

The presence of decoding unit information SEI messages for an operation point including the base layer is specified as follows:
If CpbDpbDelaysPresentFlag is equal to 1, sub_pic_hrd_params_present_flag is equal to 1, and sub_pic_cpb_params_in_pic_timing_sei_flag is equal to 0, one or more decoding unit information SEI messages applicable to the operation point shall be associated with each decoding unit in the CVS.
Otherwise, if CpbDpbDelaysPresentFlag is equal to 1, sub_pic_hrd params_present_flag is equal to 1, and sub_pic_cpb_params_in_pic_timing_sei_flag is equal to 1, one or more decoding unit information SEI messages applicable to the operation point may or may not be associated with each decoding unit in the CVS.
Otherwise (CpbDpbDelaysPresentFlag is equal to 0 or sub_pic_hrd_params_present_flag is equal to 0), in the CVS there shall be no decoding unit that is associated with a decoding unit information SEI message applicable to the operation point.

When the buffering period SEI message is non-nested or is directly contained in a scalable nesting SEI message within an SEI NAL unit with nuh_layer_id equal to 0, the set of NAL units associated with a decoding unit information SEI message consists, in decoding order, of the SEI NAL unit containing the decoding unit information SEI message and all subsequent NAL units in the access unit up to but not including any subsequent SEI NAL unit containing a decoding unit information SEI message with a different value of decoding_unit_idx. Each decoding unit shall include at least one VCL NAL unit. All non-VCL NAL units associated with a VCL NAL unit shall be included in the decoding unit containing the VCL NAL unit.
decoding_unit_idx specifies the index, starting from 0, to the list of decoding units in the current access unit, of the decoding unit associated with the decoding unit information SEI message. The value of decoding_unit_idx shall be in the range of 0 to PicSizeInCtbsY-1, inclusive.

A decoding unit identified by a particular value of duldx includes and only includes all NAL units associated with all decoding unit information SEI messages that have decoding_unit_idx equal to duldx. Such a decoding unit is also referred to as associated with the decoding unit information SEI messages having decoding_unit_idx equal to duldx.

For any two decoding units duA and duB in one access unit with decoding_unit_idx equal to duIdxA and duldxB, respectively, where duldxA is less than duIdxB, duA shall precede duB in decoding order.

A NAL unit of one decoding unit shall not be present, in decoding order, between any two NAL units of another decoding unit.
du_spt_cpb_removal_delay_increment specifies the duration, in units of clock sub-ticks, between the nominal CPB times of the last decoding unit in decoding order in the current access unit and the decoding unit associated with the decoding unit information SEI message. This value is also used to calculate an earliest possible time of arrival of decoding unit data into the CPB for the HSS, as specified in Annex C or clause F.13. The syntax element is represented by a fixed length code whose length in bits is given by du_cpb_removal_delay_increment_length_minus1+1. When the decoding unit associated with the decoding unit information SEI message is the last decoding unit in the current access unit, the value of du_spt_cpb_removal_delay_increment shall be equal to 0.
dpb_output_du_delay_present_flag equal to 1 specifies the presence of the pic_spt_dpb_output_du_delay syntax element in the decoding unit information SEI message. dpb_output_du_delay_present_flag equal to 0 specifies the absence of the pic_spt_dpb_output_du_delay syntax element in the decoding unit information SEI message.
pic_spt_dpb_output_du_delay is used to compute the DPB output time of the picture when SubPicHrdFlag is equal to 1. It specifies how many sub clock ticks to wait after removal of the last decoding unit in an access unit from the CPB before the decoded picture is output from the DPB. When not present, the value of pic_spt_dpb_output_du_delay is inferred to be equal to pic_dpb_output_du_delay.

The length of the syntax element pic_spt_dpb_output_du_delay is given in bits by dpb_output_delay_du_length_minus1+1.

When the buffering period SEI message is non-nested or is directly contained in a scalable nesting SEI message within an SEI NAL unit with nuh_layer_id equal to 0, it is a requirement of bitstream conformance that all decoding unit information SEI messages that are associated with the same access unit, apply to the same operation point, and have dpb_output_du_delay_present_flag equal to 1 shall have the same value of pic_spt_dpb_output_du_delay.

The output time derived from the pic_spt_dpb_output_du_delay of any picture that is output from an output timing conforming decoder shall precede the output time derived from the pic_spt_dpb_output_du_delay of all pictures in any subsequent CVS in decoding order.

The picture output order established by the values of this syntax element shall be the same order as established by the values of PicOrderCntVal.

For pictures that are not output by the “bumping” process because they precede, in decoding order, an IRAP picture with NoRaslOutputFlag equal to 1 that has no_output_of_prior_pics_flag equal to 1 or inferred to be equal to 1, the output times derived from pic_spt_dpb_output_du_delay shall be increasing with increasing value of PicOrderCntVal relative to all pictures within the same CVS.

For any two pictures in the CVS, the difference between the output times of the two pictures when SubPicHrdFlag is equal to 1 shall be identical to the same difference when SubPicHrdFlag is equal to 0.

Recovery_point SEI:

| | Descriptor |
|---|---|
| recovery_point( payloadSize ) { | |
| recovery_poc_cnt | se(v) |
| exact_match_flag | u(1) |
| broken_link_flag | u(1) |
| } | |

The recovery point SEI message assists a decoder in determining when the decoding process will produce acceptable pictures for display after the decoder initiates random access or after the encoder indicates a broken link in the CVS. When the decoding process is started with the access unit in decoding order associated with the recovery point SEI message, all decoded pictures at or subsequent to the recovery point in output order specified in this SEI message are indicated to be correct or approximately correct in content. Decoded pictures produced by random access at or before the picture associated with the recovery point SEI message need not be correct in content until the indicated recovery point, and the operation of the decoding process starting at the picture associated with the recovery point SEI message may contain references to pictures unavailable in the decoded picture buffer.

In addition, by use of the broken_link_flag, the recovery point SEI message can indicate to the decoder the location of some pictures in the bitstream that can result in serious visual artefacts when displayed, even when the decoding process was begun at the location of a previous IRAP access unit in decoding order.
NOTE: The broken link_flag can be used by encoders to indicate the location of a point after which the decoding process for the decoding of some pictures may cause references to pictures that, though available for use in the decoding process, are not the pictures that were used for reference when the bitstream was originally encoded (e.g., due to a splicing operation performed during the generation of the bitstream).

When random access is performed to start decoding from the access unit associated with the recovery point SEI message, the decoder operates as if the associated picture was the first picture in the bitstream in decoding order, and the variables prevPicOrderCntLsb and prevPicOrderCntMsb used in derivation of PicOrderCntVal are both set equal to 0.
NOTE: When HRD information is present in the bitstream, a buffering period SEI message should be associated with the access unit associated with the recovery point SEI message in order to establish initialization of the HRD buffer model after a random access.

Any SPS or PPS RBSP that is referred to by a picture associated with a recovery point SEI message or by any picture following such a picture in decoding order shall be available to the decoding process prior to its activation, regardless of whether or not the decoding process is started at the beginning of the bitstream or with the access unit, in decoding order, that is associated with the recovery point SEI message.
recovery_poc_cnt specifies the recovery point of decoded pictures in output order. If there is a picture picA that follows the current picture (i.e., the picture associated with the current SEI message) in decoding order in the CVS and that has PicOrderCntVal equal to the PicOrderCntVal of the current picture plus the value of recovery_poc_cnt, the picture picA is referred to as the recovery point picture. Otherwise, the first picture in output order that has PicOrderCntVal greater than the PicOrderCntVal of the current picture plus the value of recovery_poc_cnt is referred to as the recovery point picture. The recovery point picture shall not precede the current picture in decoding order. All decoded pictures in output order are indicated to be correct or approximately correct in content starting at the output order position of the recovery point picture. The value of recovery_poc_cnt shall be in the range of-MaxPicOrderCntLsb/2 to MaxPicOrderCntLsb/2-1, inclusive.
exact_match_flag indicates whether decoded pictures at and subsequent to the specified recovery point in output order derived by starting the decoding process at the access unit associated with the recovery point SEI message will be an exact match to the pictures that would be produced by starting the decoding process at the location of a previous IRAP access unit, if any, in the bitstream. The value 0 indicates that the match may not be exact and the value 1 indicates that the match will be exact. When exact match_flag is equal to 1, it is a requirement of bitstream conformance that the decoded pictures at and subsequent to the specified recovery point in output order derived by starting the decoding process at the access unit associated with the recovery point SEI message shall be an exact match to the pictures that would be produced by starting the decoding process at the location of a previous IRAP access unit, if any, in the bitstream.
NOTE: When performing random access, decoders should infer all references to unavailable pictures as references to pictures containing only intra coding blocks and having sample values given by Y equal to (1«(BitDepthy-1)), Cb and Cr both equal to (1«(BitDepthc-1)) (mid-level grey), regardless of the value of exact match_flag.

When exact_match_flag is equal to 0, the quality of the approximation at the recovery point is chosen by the encoding process and is not specified in this specification.
broken_link_flag indicates the presence or absence of a broken link in the NAL unit stream at the location of the recovery point SEI message and is assigned further semantics as follows:
   If broken link_flag is equal to 1, pictures produced by starting the decoding process at the location of a previous IRAP access unit may contain undesirable visual artefacts to the extent that decoded pictures at and subsequent to the access unit associated with the recovery point SEI message in decoding order should not be displayed until the specified recovery point in output order.
   Otherwise (broken link_flag is equal to 0), no indication is given regarding any potential presence of visual artefacts.

When the current picture is a BLA picture, the value of broken_link_flag shall be equal to 1.

Regardless of the value of the broken link_flag, pictures subsequent to the specified recovery point in output order are specified to be correct or approximately correct in content.

Region_refresh_info SEI:

| | Descriptor |
|---|---|
| region_refresh_info( payloadSize ) { | |
| refreshed_region_flag | u(1) |
| } | |

The region refresh information SEI message indicates whether the slice segments that the current SEI message applies to belong to a refreshed region of the current picture (e.g., as defined below).

An access unit that is not an IRAP access unit and that contains a recovery point SEI message is referred to as a gradual decoding refresh (GDR) access unit, and its corresponding picture is referred to as a GDR picture. The access unit corresponding to the indicated recovery point picture is referred to as the recovery point access unit. If there is a picture that follows the GDR picture in decoding order in the CVS and that has PicOrderCntVal equal to the PicOrderCntVal of the GDR picture plus the value of recovery_poc_cnt in the recovery point SEI message, let the variable lastPicInSet be the recovery point picture. Otherwise, let lastPicInSet be the picture that immediately precedes the recovery point picture in output order. The picture lastPicInSet shall not precede the GDR picture in decoding order.

Let gdrPicSet be the set of pictures starting from a GDR picture to the picture lastPicInSet, inclusive, in output order. When the decoding process is started from a GDR access unit, the refreshed region in each picture of the gdrPicSet is indicated to be the region of the picture that is correct or approximately correct in content, and, when lastPicInSet is the recovery point picture, the refreshed region in lastPicInSet covers the entire picture. The slice segments to which a region refresh information SEI message applies consist of all slice segments within the access unit that follow the SEI NAL unit containing the region refresh information SEI message and precede the next SEI NAL unit containing a region refresh information SEI message (if any) in decoding order. These slice segments are referred to as the slice segments associated with the region refresh information SEI message.

Let gdrAuSet be the set of access units corresponding to gdrPicSet. A gdrAuSet and the corresponding gdrPicSet are referred to as being associated with the recovery point SEI message contained in the GDR access unit. Region refresh information SEI messages shall not be present in an access unit unless the access unit is included in a gdrAuSet associated with a recovery point SEI message. When any access unit that is included in a gdrAuSet contains one or more region refresh information SEI messages, all access units in the gdrAuSet shall contain one or more region refresh information SEI messages.
refreshed_region_flag equal to 1 indicates that the slice segments associated with the current SEI message belong to the refreshed region in the current picture. refreshed_region_flag equal to 0 indicates that the slice segments associated with the current SEI message may not belong to the refreshed region in the current picture.

When one or more region refresh information SEI messages are present in an access unit and the first slice segment of the access unit in decoding order does not have an associated region refresh information SEI message, the value of refreshed_region_flag for the slice segments that precede the first region refresh information SEI message is inferred to be equal to 0.

When lastPicInSet is the recovery point picture, and any region refresh SEI message is included in a recovery point access unit, the first slice segment of the access unit in decoding order shall have an associated region refresh SEI message, and the value of refreshed_region flag shall be equal to 1 in all region refresh SEI messages in the access unit.

When one or more region refresh information SEI messages are present in an access unit, the refreshed region in the picture is specified as the set of CTUs in all slice segments of the access unit that are associated with region refresh information SEI messages that have refreshed_region_flag equal to 1. Other slice segments belong to the non-refreshed region of the picture.

It is a requirement of bitstream conformance that when a dependent slice segment belongs to the refreshed region, the preceding slice segment in decoding order shall also belong to the refreshed region.

Let gdrRefreshedSliceSegmentSet be the set of all slice segments that belong to the refreshed regions in the gdrPicSet. When a gdrAuSet contains one or more region refresh information SEI messages, it is a requirement of bitstream conformance that the following constraints all apply:
The refreshed region in the first picture included in the corresponding gdrPicSet in decoding order that contains any refreshed region shall contain only coding units that are coded in an intra coding mode.
For each picture included in the gdrPicSet, the syntax elements in gdrRefreshedSliceSegmentSet shall be constrained such that no samples or motion vector values outside of gdrRefreshedSliceSegmentSet are used for interprediction in the decoding process of any samples within gdrRefreshedSliceSegmentSet.
For any picture that follows the picture lastPicInSet in output order, the syntax elements in the slice segments of the picture shall be constrained such that no samples or motion vector values outside of gdrRefreshedSliceSegmentSet are used for interprediction in the decoding process of the picture other than those of the other pictures that follow the picture lastPicInSet in output order.

We will now describe the corresponding network abstraction layer unit (NALU).
network abstraction layer (NAL) unit: A syntax structure containing an indication of the type of data to follow and bytes containing that data in the form of a Raw Byte Sequence Payload (RBSP) interspersed as necessary with emulation prevention bytes.
network abstraction layer (NAL) unit stream: A sequence of NAL units.
video coding layer (VCL) NAL unit: A collective term for coded slice segment NAL units and the subset of NAL units that have reserved values of nal_unit_type that are classified as VCL NAL units in this Specification.

| | Descriptor |
|---|---|
| nal_unit_header( ) { | |
| forbidden_zero_bit | f(1) |
| nal_unit_type | u(6) |
| nuh_layer_id | u(6) |
| nuh_temporal_id_plus1 | u(3) |
| } | |

nal_unit_type specifies the type of RBSP data structure contained in the NAL unit as specified in the following Table. NAL units that have nal_unit_type in the range of UNSPEC48 . . . . UNSPEC63, inclusive, for which semantics are not specified, shall not affect the decoding process specified in this specification.
NOTE: NAL unit types in the range of UNSPEC48 . . . . UNSPEC63 may be used as determined by the application. No decoding process for these values of nal_unit_type is specified in this specification. Since different applications might use these NAL unit types for different purposes, particular care must be exercised in the design of encoders that generate NAL units with these nal_unit_type values, and in the design of decoders that interpret the content of NAL units with these nal_unit_type values.

For purposes other than determining the amount of data in the decoding units of the bitstream (as specified in Annex C), decoders shall ignore (remove from the bitstream and discard) the contents of all NAL units that use reserved values of nal_unit_type.
NOTE: This requirement allows future definition of compatible extensions to this specification.

TABLE
NAL unit type codes and NAL unit type classes.

| | Name of | | NAL unit |
|---|---|---|---|
| nal_unit_type | nal_unit_type | Content of NAL unit and RBSP syntax structure | type class |
| 0 | TRAIL_N | Coded slice segment of a non-TSA, non-STSA | VCL |
| 1 | TRAIL_R | trailing picture | |
| | | slice_segment_layer_rbsp( ) | |
| 2 | TSA_N | Coded slice segment of a TSA picture | VCL |
| 3 | TSA_R | slice_segment_layer_rbsp( ) | |
| 4 | STSA_N | Coded slice segment of an STSA picture | VCL |
| 5 | STSA_R | slice_segment_layer_rbsp( ) | |
| 6 | RADL_N | Coded slice segment of a RADL picture | VCL |
| 7 | RADL_R | slice_segment_layer_rbsp( ) | |
| 8 | RASL_N | Coded slice segment of a RASL picture | VCL |
| 9 | RASL_R | slice_segment_layer_rbsp( ) | |
| 10 | RSV_VCL_N10 | Reserved non-IRAP SLNR VCL NAL unit types | VCL |
| 12 | RSV_VCL_N12 | | |
| 14 | RSV_VCL_N14 | | |
| 11 | RSV_VCL_R11 | Reserved non-IRAP sub-layer reference VCL | VCL |
| 13 | RSV_VCL_R13 | NAL unit types | |
| 15 | RSV_VCL_R15 | | |
| 16 | BLA_W_LP | Coded slice segment of a BLA picture | VCL |
| 17 | BLA_W_RADL | slice_segment_layer_rbsp( ) | |
| 18 | BLA_N_LP | | |
| 19 | IDR_W_RADL | Coded slice segment of an IDR picture | VCL |
| 20 | IDR_N_LP | slice_segment_layer_rbsp( ) | |
| 21 | CRA_NUT | Coded slice segment of a CRA picture | VCL |
| | | slice_segment_layer_rbsp( ) | |
| 22 | RSV_IRAP_VCL22 | Reserved IRAP VCL NAL unit types | VCL |
| 23 | RSV_IRAP_VCL23 | | |
| 24 . . . 31 | RSV_VCL24 . . . | Reserved non-IRAP VCL NAL unit types | VCL |
| | RSV_VCL31 | | |
| 32 | VPS_NUT | Video parameter set | non-VCL |
| | | video_parameter_set_rbsp( ) | |
| 33 | SPS_NUT | Sequence parameter set | non-VCL |
| | | seq_parameter_set_rbsp( ) | |
| 34 | PPS_NUT | Picture parameter set | non-VCL |
| | | pic_parameter_set_rbsp( ) | |
| 35 | AUD_NUT | Access unit delimiter | non-VCL |
| | | access_unit_delimiter_rbsp( ) | |
| 36 | EOS_NUT | End of sequence | non-VCL |
| | | end_of_seq_rbsp( ) | |
| 37 | EOB_NUT | End of bitstream | non-VCL |
| | | end_of_bitstream_rbsp( ) | |
| 38 | FD_NUT | Filler data | non-VCL |
| | | filler_data_rbsp( ) | |
| 39 | PREFIX_SEI_NUT | Supplemental enhancement information | non-VCL |
| 40 | SUFFIX_SEI_NUT | sei_rbsp( ) | |
| 41 . . . 47 | RSV_NVCL41 . . . | Reserved | non-VCL |
| | RSV_NVCL47 | | |
| 48 . . . 63 | UNSPEC48 . . . | Unspecified | non-VCL |
| | UNSPEC63 | | |

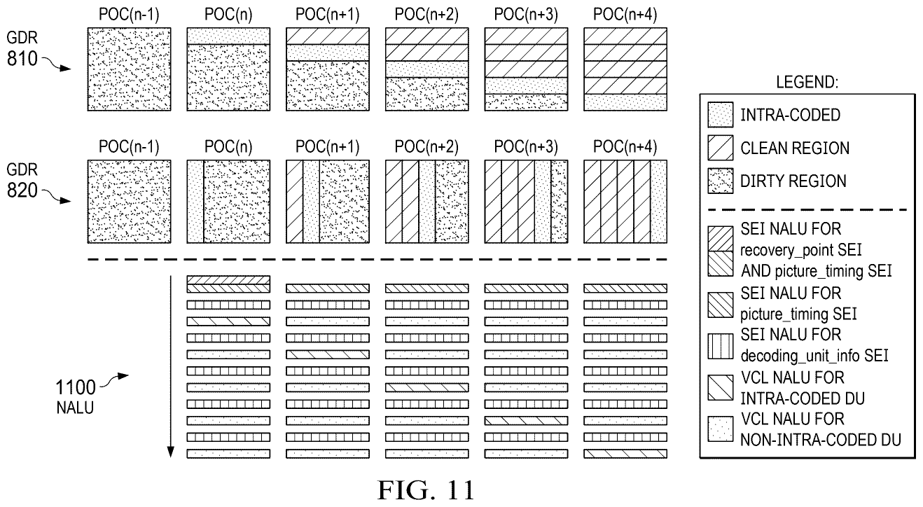

FIG. 11 is a block diagram illustrating a NAL unit stream (1100) according to some examples. More specifically, the NAL unit stream (1100) can be used to implement the GDR configuration (810 or 820) previously described in reference to FIG. 8. The various components of the NAL unit stream (1100) are indicated in accordance with the provided legend and are used to encapsulate the above-described SEI and VCL.

### Rateless Coding

Conventional FEC coding typically uses a fixed coding rate between the source packets and parity packets. Once the coding rate is determined and the parity packets are generated, the error protection strength is set and cannot adapt to varying channel conditions. In contrast, a rateless code can generate a variable number of coded packets. As long as the number of successfully received packets is no less than the number of source packets, the receiver will be able to recover the source information. The transmitted number of coded packets may depend on the real-time channel conditions, and there is no need to re-encode the FEC-coded stream or prepare multiple versions of the FEC-coded stream with different protection strengths. Representative examples of rateless codes include, but are not limited to, Luby transform (LT) codes, Raptor codes, rateless fountain codes, rateless spinal codes, and random linear network coding (RLNC) codes. For illustration purposes and without any implied limitations, some examples are described below in reference to RLNC codes. Based on the provided description, a person of ordinary skill in the pertinent art will be able to make and use other examples in which other types of rateless codes are used.

The RLNC code, which provides only one representative example of rateless coding, is described in Dejan Vukobratovic and Vladimir Stankovic, “Unequal Error Protection Random Linear Coding Strategies for Erasure Channels,” IEEE TRANSACTIONS ON COMMUNICATIONS, VOL. 60, NO. 5, May 2012, pp. 1243-1252, which is incorporated herein by reference in its entirety. RLNC achieves the rateless property by applying a random linear combination of source packets with coefficients randomly selected from a given finite field GF(2^{q}). For example, by given the source message x=[x₀, x₁, . . . , x_{C-1}], a set of randomly selected element from GF(2^{q}) as

$${ω}^{( k )} = [ {ω}_{0}^{( k )} , {ω}_{1}^{( k )} , … , {ω}_{c - 1}^{( k )} ] ,$$

the new coded packet is constructed as

$${y}^{( k )} = {Σ}_{i = 0}^{C - 1} {ω}_{i}^{( k )} \cdot {x}_{i} \qquad ( 1 )$$

The resulting coded packet has the same length as the source packet L. Each coded packet has the information for the coefficients (ω) to facilitate the decoding. Note that it is also feasible to use a pseudo random number generator to signal the coefficients, and we just need to transmit the random-generator seed.

We can generate multiple y^{(k)} with different random ω(k). At the decoder, as long as we receive C packets, one can organize those C coefficients and the received signal into the following matrix/vector form:

$$[ \begin{matrix}{y}^{( 0 )} \\ \\ {y}^{( M - 1 )}\end{matrix} ] = [ \begin{matrix}{ω}_{0}^{( 0 )} & … & {ω}_{C - 1}^{( 0 )} \\ ⋮ & ⋱ & ⋮ \\ {ω}_{0}^{( M - 1 )} & … & {ω}_{C - 1}^{( M - 1 )}\end{matrix} ] [ \begin{matrix}{x}_{0} \\ ⋮ \\ {x}_{C - 1}\end{matrix} ] \qquad ( 2 )$$

An abbreviated form of Eq. (2) is:

$$y = Wx \qquad ( 3 )$$

One can use a Gaussian elimination method to recover x. Also note that M can be much larger than C.

### Multiple Perspective Audio and Video (MPAV)

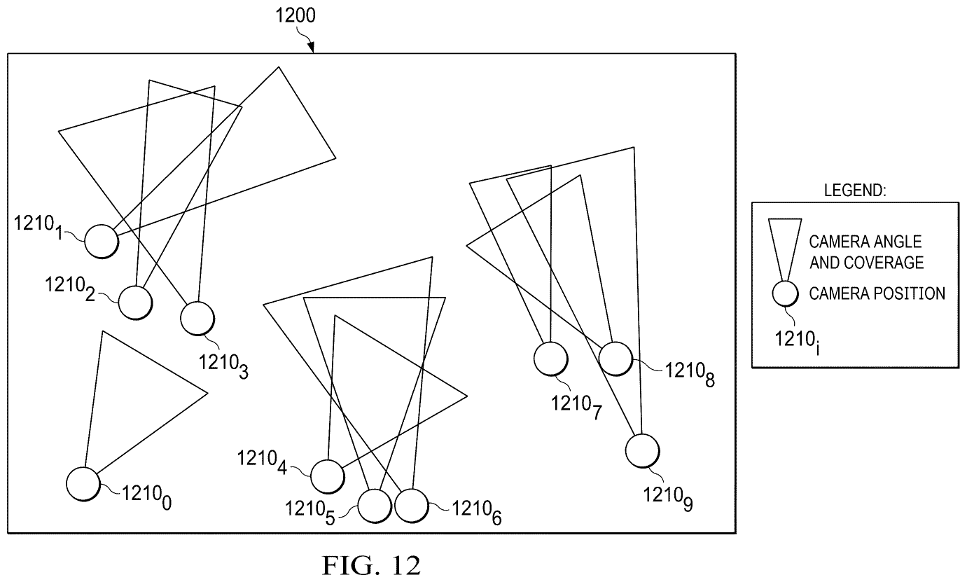

FIG. 12 is a block diagram illustrating a configuration (1200) for capturing MPAV content according to some examples. At time instance t, there are Nₜ=10 cameras (1210₀-1210₉) in the configuration (1200). Herein, we denote the set of the cameras (1210₀-1210₉) as Γₜ. The cameras (1210₀-1210₉) operate to capture the same event or scene, with each of the cameras (1210₀-1210₉) being located at a different respective location and having a respective orientation, e.g., as indicated in FIG. 12.

Let us denote the location (x, y) for the i^{th} camera as L_{t,i}. The shooting angle and the coverage for the i^{th} camera are represented as A_{t,i} and R_{t,i}. Each of the cameras (1210₀-1210₉) has a respective location, shooting angle, and shooting coverage {(L_{t,i}, A_{t,i}, R_{t,i}) for i=0, . . . , Nₜ−1}. In some examples, the camera locations can be obtained via floor plan estimation. Each camera may be operated by a different respective user and faced at a different respective angle with a respective coverage, e.g., characterized by zoom-in/out and the camera height/width ratio.

Owing to the two aforementioned factors, i.e., (1) the limited bandwidth from the streaming server to the playback device and (2) decoding-complexity limitations at the playback device, it is typically unrealistic to stream all cameras' bitstreams to the end user side. To address this problem, some embodiments categorize the camera views into at least three different types:
Main view. A main view is the current camera/perspective position an end-user is watching. Normally, it is preferred for the main view to display a relatively high (e.g., the highest available) spatial resolution of video and a relatively high (e.g., the highest available) resolution of audio, subject to the currently available bandwidth.
Side view. A side view is the other relatively highly relevant view of the event/scene that provides additional information not available from the main view. For each main view, there will be several associated side views (but fewer than all of the other views). Those side views are not watched by the end user at the current moment (or at least not watched in a full screen mode but may be overlayed on top of the main view video as video thumbnails). One of the side views is very likely to be switched to from the current view. When the switching request arises, an example embodiment is enabled to perform fast switching from the main view to the requested side view(s). To enable such fast switching, we allow lower spatial resolution of a side view bitstream comparing to that of the main view. In some examples, a practical and effective solution is to transmit the side views in a pre-fetch fashion to be decoded together or along with the main view.
Rare view. Rare views are the perspectives that do not belong to the set of key views from the side view perspectives. For example, a rare view may provide more detailed (e.g., finer resolution) information but some of that information might already be covered in a related side view. The rare views form a set of on-demand views to be invoked only when the end users specifically request them. To enable fast switching thereto, the rare view bitstreams can be encoded at a lower spatial resolution and with high intra frame frequency, e.g., smaller groups of pictures, GOPs. Therefore, once the request of rare view is submitted, the end user can download and decode the corresponding rare view bitstream as fast as possible.

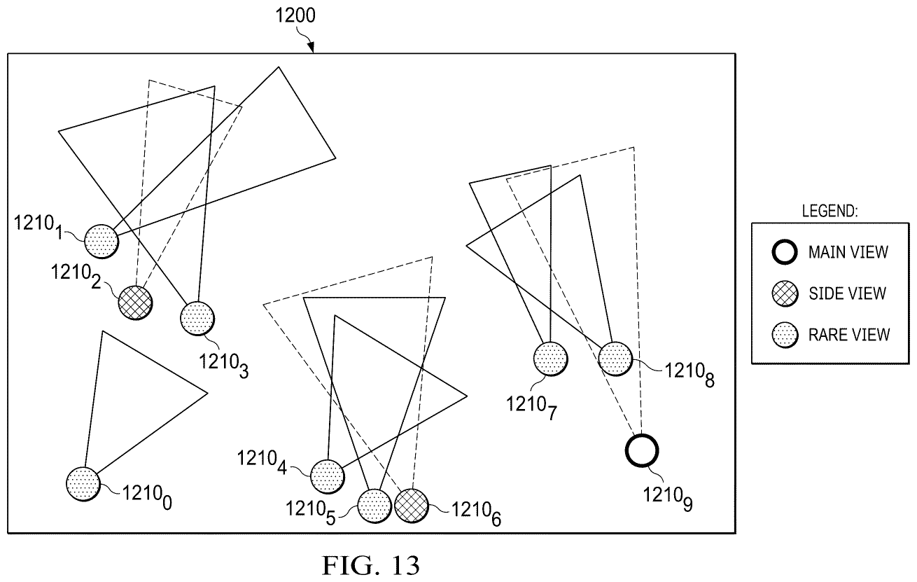

FIG. 13 is a block diagram illustrating the camera views of the MPAV configuration (1200) sorted into main, side, and rare views according to some examples. In the example shown, the tenth camera view (1210₉) is categorized as the main view. The third and seventh camera views (1210₂, 1210₆) are categorized as the side views. The remaining camera views are categorized as the rare views. The view switching probability in the MPAV configuration (1200) from view a to view b can be measured or approximated and is denoted as w^{a→b}.

### Unequal Error Protection (UEP) for GDR

Some examples of error protection applied to the GDR bitstream are based on relative importance and priority of various decoding units (DUs) of the MPAV bitstream(s). More specifically, a GDR+UEP framework disclosed herein uses an unequal error protection mechanism to reach nearly optimal video quality. The optimization objects and constraints are described in more detail below. Some examples also address the error concealment aspects of the disclosed GDR+UEP framework.

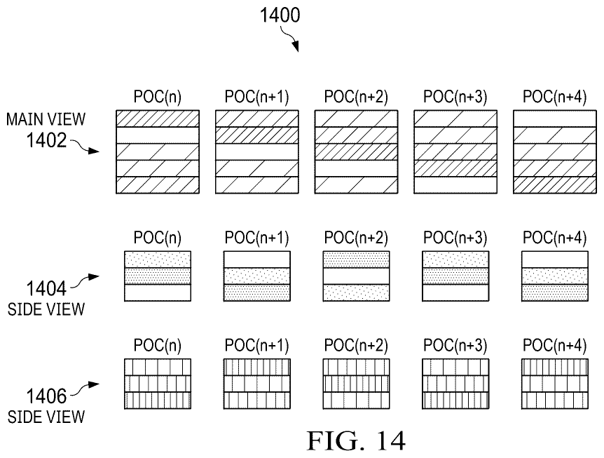

FIG. 14 is a block diagram illustrating a use of GDR in a multiple perspective video (1400) according to some examples. The video (1400) has a main view (1402) and first and second side views (1404, 1406). The main view (1402) has a higher spatial resolution at a higher bit rate than the side views (1404, 1406), which have a smaller spatial resolution at a lower bit rate. The main view (1402) has five decoding units (DUs) whereas each of the side views (1404, 1406) has three DUs, with the various DUs being illustratively shown as picture slices. The relative priority/importance is indicated in FIG. 14 by the different grades of brightness/saturation of the diagrammatic fill of the DUs.

Let us consider the main view (1402) as an example. The first DU of the main view (1402) at POC (n) is intra-coded and will be refreshed at POC (n+5). The second DU of the main view (1402) will be intra-coded at POC (n+1) and POC (n+6). The 3^{rd}, 4^{th}, and 5^{th} DUs of the main view (1402) will be intra-coded at POC (n+2), POC (n+3), and POC (n+4), respectively.

For the side view (1404), the 1^{st}, 2^{nd}, and 3^{rd} DUs will be intra-coded at POC (n+2), POC (n), and POC (n+1), respectively. For the side view (1406), the 1^{st}, 2^{nd}, the 3^{rd} DUs will be intra-coded at POC (n+1), POC (n+2), and POC (n), respectively.

Without loss of generality, we can assign the main view (e.g., 1402) as having the view index 0. Among all side views (e.g., 1404, 1406), we can assign the view index according to the view switching probability. The view with highest switching probability from the main view to this side view has the view index 1, and the side view with the next highest switching probability has the view index 2, and so on. In total, we have Nᵥ views.

Let us denote: the k^{th} DU at POC(n) for the view index v as

$${U}_{n}^{v , k} ;$$

the type of each DU as a function T( ) of intra-coded and inter-coded as {intra, inter}; the GDR period for each view as G^{v}.

Without loss of generality, let the 1^{st} DU at POC (n) for the main view be intra-coded, i.e.

$$T ( {U}_{n}^{0 , 0} ) = intra .$$

There are G⁰ units,

$$\{ {U}_{n}^{0 , 0} , {U}_{n + 1}^{0 , 0} , … {U}_{n + {G}^{0} - 1}^{0 , 0} \} ,$$

along the time domain for the 1^{st} DU position. The intra-coded DU, which is

$${U}_{n}^{0 , 0} ,$$

has the highest relative importance because without this DU, the remaining predicted DUs will not be reconstructed. The

$${U}_{n + 1}^{0 , 0}$$

at POC (n+1) has the second highest importance because a loss of this DU will cause the remaining DUs undecodable. The importance of this group of DUs can be addressed by the impact of error propagation. Let us denote this importance as a function F ( ) For the 1^{st} DU at main view, we have the highest relative importance. The corresponding mathematical expression is as follows:

$$F ( {U}_{n}^{0 , 0} ) \geq F ( {U}_{n + 1}^{0 , 0} ) \geq … F ( {U}_{n + {G}^{0} - 1}^{0 , 0} ) for \frac{n}{{G}^{0}} ∈ Z \qquad ( 4 )$$

Similarly, for the DU at the kth position, we can build the relative importance/priority relationship as:

$$F ( {U}_{n + k}^{0 , k} ) \geq F ( {U}_{n + k + 1}^{0 , k} ) \geq … F ( {U}_{n + k + {G}^{0} - 1}^{0 , k} ) for \frac{n + k}{{G}^{0}} ∈ Z \qquad ( 5 )$$

If we look into each POC time instance P (n+t), the relative importance of various DUs can be expressed as follows:

$$F ( {U}_{n + t}^{0 , π ( t , {G}^{0} )} ) \geq F ( {U}_{n + t}^{0 , π ( t - 1 , {G}^{0} )} ) \geq … F ( {U}_{n + t}^{0 , π ( t - {G}^{0} + 1 , {G}^{0} )} ) for \frac{n + t}{{G}^{0}} ∈ Z \qquad ( 6 )$$

$$where$$

$$π ( t , {G}^{0} ) = \{ \begin{matrix}t ; if t ∈ [ 0 {G}^{0} - 1 ] \\ t + {G}^{0} ; o . w .\end{matrix} \qquad ( 7 )$$

By analogy, the relative importance of each DU inside each side view, with the view index v and with the GDR period G^{Sv}, can be also characterized using a similar relationship:

$$F ( {U}_{n + t}^{v , π ( t , {G}^{v} )} ) \geq F ( {U}_{n + t}^{v , π ( t - 1 , {G}^{v} )} ) \geq … F ( {U}_{n + t}^{v , π ( t - {G}^{v} + 1 , {G}^{v} )} ) for \frac{n + t}{{G}^{v}} ∈ Z \qquad ( 8 )$$

$$where$$

$$π ( t , {G}^{v} ) = \{ \begin{matrix}t ; if t ∈ [ 0 {G}^{v} - 1 ] \\ t + {G}^{v} ; o . w .\end{matrix} \qquad ( 9 )$$

The main view has a higher relative importance than side views. Among various side views, the relative importance can be determined based on the views switching probabilities, e.g., the higher the switching probability, the higher the relative importance. Without loss of generality, we can sort the views to meet the following constraint:

$${w}^{0 \to 0} \geq {w}^{0 \to 1} \geq {w}^{0 \to 2} \qquad ( 10 )$$

In addition, we also want to enforce the relative DU importance among different views. The intra-coded DU in the main view should have a higher relative importance than the intra-coded DU in a side view. Let us denote tᵥ as the DU index which has intra-coding for the view index v. The, the following inequality holds:

$$F ( {U}_{n}^{v , π ( {t}_{v} - j , {G}^{v} )} ) \geq F ( {U}_{n}^{v + 1 , π ( {t}_{v + 1} - j , {G}^{v + 1} )} ) for v ∈ \{ 0 , 1 , … , {N}_{v} - 2 \} \qquad ( 11 )$$

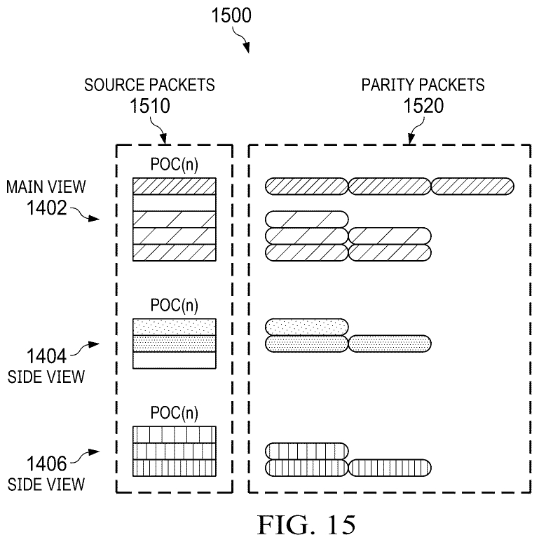

FIG. 15 is a block diagram illustrating a UEP scheme (1500) that can be applied to the multiple perspective video (1400) according to some examples. For illustration purposes and without any implied limitation, the UEP scheme (1500) is described as being applied to the video frames corresponding to POC (n). A person of ordinary skill in the pertinent art will readily understand how to apply the UEP scheme (1500) to other POC intervals without any undue experimentation.

For the error prone channel, the UEP scheme (1500) is configured to apply stronger FEC protection to more-important DUs whereas weaker or no FEC protection may be applied to less important DUs. Accordingly, for relatively more-important DUs (carried by respective source packets (1510)), the UEP scheme (1500) operates to allocate relatively more respective FEC parity packets (1520) than for relatively less-important DUs. For different ones of the views (1402, 1404, 1406), the UEP scheme (1500) is configured to assign relatively stronger FEC protection to the view(s) with higher viewing probability. FIG. 15 pictorially illustrates these concepts by showing the respective numbers of parity packets (1520) transmitted for each of the corresponding source packets (1510). For example, for the main view (1402), the relative importance of DUs, in the decreasing order, is as follows: 1^{st} (top) DU, 5^{th} (bottom) DU, 4^{th} DU, 34 DU, 2^{nd} DU. Accordingly, the 1^{st} DU is FEC-protected using three respective parity packets (1520); each of the 5^{th} and 4^{th} DUs is FEC-protected using two respective parity packets (1520); the 3^{rd} DU is FEC-protected using one respective parity packet (1520); and zero parity packets (1520) is transmitted for the 2^{nd} DU. The numbers of respective parity packets (1520) for the DUs of the side views (1404, 1406) are determined in a similar manner, as is further pictorially illustrated in FIG. 15.

In some examples, the problem of determining the protection strength for various DUs of the different views of a multiple perspective video can be formulated as an optimization problem, e.g., as described in more detail below.

Assume the packet length is L bytes, and packet loss rate is pₙ. The bandwidth is represented as Nₙ packets per frame interval. The required number of source packets for

$$DU {U}_{n}^{v , k}$$

represented as

$${S}_{n}^{v , k} .$$

If we apply the cross-packet FEC with number of parity packets as,

$${C}_{n}^{v , k} ,$$

then the packet successful decoding probability for the sending

$${C}_{n}^{v , k}$$

parity packets

$${S}_{n}^{v , k}$$

source packets can be expressed as:

$${P}_{n}^{′ v , k} ( {C}_{n}^{v , k} ) = {\sum }_{β = {C}_{n}^{v , k}}^{{S}_{n}^{v , k} + {C}_{n}^{v , k}} ( \begin{matrix}{S}_{n}^{v , k} + {C}_{n}^{v , k} \\ β\end{matrix} ) {( 1 - {p}_{n} )}^{β} {( {p}_{n} )}^{( {S}_{n}^{v , k} + {C}_{n}^{v , k} - β )} \qquad ( 12 )$$

The total number of packets in all DUs is limited to (cannot exceed) Nₙ. This condition is expressed as follows:

$${\sum }_{v = 0}^{{N}_{v} - 1} {\sum }_{k = 0}^{{G}^{v} - 1} ( {S}_{n}^{v , k} + {C}_{n}^{v , k} ) \leq {N}_{n} \qquad ( 13 )$$

We can also denote the expected distortion for the received DU compared to the source DU (with no compression) as

$${D}_{n}^{v , k} .$$

Let us denote as tᵥ the DU index that has intra-coding in view v. The overall expected distortion can then be expressed as follows:

$$D ( \{ {C}_{n}^{v , k} \} ) = {\sum }_{v = 0}^{{N}_{v} - 1} {w}^{0 \to v} {\sum }_{k = 0}^{{G}^{v} - 1} {P}_{n}^{′ v , k} ( {C}_{n}^{v , k} ) \cdot {D}_{n}^{v , k} \qquad ( 14 )$$

We can represent the combined effect of w^{0→v} and

$${P}_{n}^{′ v , k} ( {C}_{n}^{v , k} )$$

in the form of another function:

$${P}_{n}^{v , k} ( {C}_{n}^{v , k} ) = {w}^{0 \to v} {P}_{n}^{′ v , k} ( {C}_{n}^{v , k} ) \qquad ( 15 )$$

The overall expected distortion can then be expressed as follows:

$$D ( \{ {C}_{n}^{v , k} \} ) = {\sum }_{v = 0}^{{N}_{v} - 1} {\sum }_{k = 0}^{{G}^{v} - 1} {P}_{n}^{v , k} ( {C}_{n}^{v , k} ) \cdot {D}_{n}^{v , k} \qquad ( 16 )$$

Based on the above, the problem of optimizing (e.g., minimizing subject to certain constraints) the overall distortion can be reformulated as Problem A1 presented below.

Problem A1 - Overall Distortion

```
$arg {min}_{\{ {C}_{n}^{v , k} \}} D ( \{ {C}_{n}^{v , k} \} )$
Subject to
(A. 1) intra-view priority constraint
  For v ∈ {0, 1, ... , Nᵥ − 1} and j = ∈ {0, 1, ... , G^{v} − 2}
  ${P}_{n}^{v , π ( {t}_{v} - j , {G}^{v} )} ( {C}_{n}^{v , π ( {t}_{v} - j , {G}^{v} )} ) \geq {P}_{n}^{v , π ( {t}_{v} - j - 1 , {G}^{v} )} ( {C}_{n}^{v , π ( {t}_{v} - j - 1 , {G}^{v} )} )$
(A. 2) inter-view priority constraint
  For v ∈ {0, 1, ... , Nᵥ − 2} and j ∈ {0, 1, ... , min(G^{v}, G^{v+1}) − 1}
  ${P}_{n}^{v , π ( {t}_{v} - j , {G}^{v} )} ( {C}_{n}^{v , π ( {t}_{v} - j , {G}^{v} )} ) \geq {P}_{n}^{v + 1 , π ( {t}_{v + 1} - j , {G}^{v + 1} )} ( {C}_{n}^{v + 1 , π ( {t}_{v + 1} - j , {G}^{v + 1} )} )$
(A. 3) bandwidth constraint
  ${\sum }_{v = 0}^{{N}_{v} - 1} {\sum }_{k = 0}^{{G}^{v} - 1} ( {S}_{n}^{v , k} + {C}_{n}^{v , k} ) \leq {N}_{n}$
```

Knowing that Problem A1 is NP hard, one approach can be to find the solution

$$\{ {C}_{n}^{v , k} \}$$

using a greedy algorithm via multiple iterations. At the beginning, none of the parity packets are assigned, i.e.,

$$\{ {C}_{n , ( 0 )}^{v , k} = 0 \} .$$

In the i^{th} iteration, we assign one additional parity packet to all possible (v, k) DUs based on the current parity packet assignment, evaluate the cost

$$D ( \{ {C}_{n , ( i )}^{v , k} \} ) ,$$

and select the (v*, k*) identifier that can provide the lowest cost. We continue this process until no more packets can be assigned. The corresponding algorithm, denoted as Algorithm A1, is illustrated using the following example pseudocode.

Algorithm A1

```
$Set all {C}_{n}^{v , k} = 0 for all valid ( v , k ) . // initialize all assignment to 0$
$While {\sum }_{v = 0}^{{N}_{v} - 1} {\sum }_{k = 0}^{{G}^{v} - 1} ( {S}_{n}^{v , k} + {C}_{n}^{v , k} ) \leq {N}_{n} // until no packet to assign$
  Ω = {} // reset valid list to empty set
  for each (v, k) // test (v, k)
    // copy all parity packet assignment to a temp space
    ${C}_{n}^{′ v , k} = {C}_{n}^{v , k} for all ( v , k )$
    // assign one parity packet
    ${C}_{n}^{′ v , k} = {C}_{n}^{v , k} + 1$
    $if \{ {C}_{n}^{′ v , k} \} meets constraint ( A . 1 ) and ( A . 2 )$
      // compute cost
      $D ( \{ {C}_{n}^{′ v , k} \} )$
      // add (v, k) to valid list
      Ω = Ω ∪ (v, k)
    end
  end
  // select the (v, k) in Ω having the minimal cost
  $( {v}^{*} , {k}^{*} ) = arg {min}_{\{ ( v , k ) ∈ Ω \}} D ( \{ {C}_{n}^{′ v , k} \} )$
  // assign one parity packet to this (v, k)
  ${C}_{n}^{{v}^{*} , {k}^{*}} = {C}_{n}^{{v}^{*} , {k}^{*}} + 1$
end
```

Since the intra-coded DU is typically changed every frame in each view, the perceived video quality might fluctuate along the time domain in each DU location. To address this problem, one can add the temporal domain quality consistency constraint in the problem formulation. The objective function can additionally address the quality difference in each DU location between the two pertinent frames. In one example, the resulting constraint is expressed as follows:

$$Δ {D}_{1} ( \{ {C}_{n}^{v , k} \} ) = {\sum }_{v = 0}^{{N}_{v} - 1} {\sum }_{k = 0}^{{G}^{v} - 1} Q ( {P}_{n - 1}^{v , k} ( {C}_{n - 1}^{v , k} ) \cdot {D}_{n - 1}^{v , k} , {P}_{n}^{v , k} ( {C}_{n}^{v , k} ) \cdot {D}_{n}^{v , k} ) \qquad ( 17 )$$

where Q(,) is a function used to compute the expected quality difference between the two DUs. In one example, an L1 or L2 loss can be used for this purpose. The L1 loss is also known as Least Absolute Deviations (LAD), while the L2 loss is also known as Least Squares Errors (LSE).

Yet another approach includes minimizing the difference between two intra-coded DUs in the frame n and the frame n−1. The corresponding mathematical expression is as follows:

$$Δ {D}_{2} ( \{ {C}_{n}^{v , k} \} ) = {\sum }_{v = 0}^{{N}_{v} - 1} Q ( {P}_{n - 1}^{v + 1 , {t}_{v + 1}} ( {C}_{n - 1}^{v + 1 , {t}_{v + 1}} ) \cdot {D}_{n - 1}^{v , , {t}_{v + 1}} , {P}_{n}^{v , {t}_{v}} ( {C}_{n}^{v , {t}_{v}} ) \cdot {D}_{n}^{v , {t}_{v}} ) \qquad ( 18 )$$

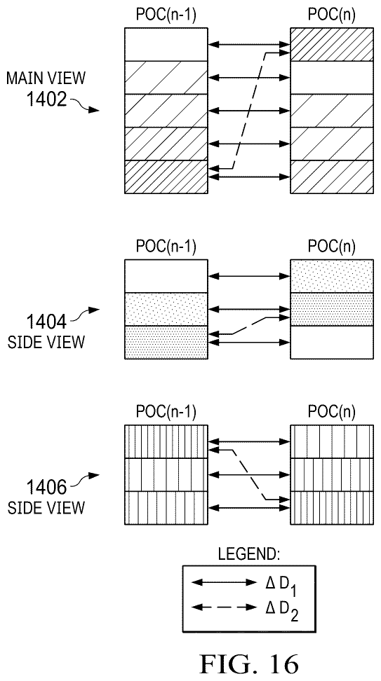

FIG. 16 is a block diagram illustrating the temporal domain quality consistency constraints ΔD₁ and ΔD₂ (also see Eqs. (17)-(18)) being used to implement the UEP scheme (1500) according to some examples. For illustration purposes and without any implied limitation, the temporal domain quality consistency constraints ΔD₁ and ΔD₂ are described as being applied to the video frames corresponding to POC (n−1) and POC (n). A person of ordinary skill in the pertinent art will readily understand how to apply the temporal domain quality consistency constraints ΔD₁ and ΔD₂ to other POC intervals without any undue experimentation.

In some examples, the UEP scheme (1500) can be configured to utilize the objective function implementing a weighted consideration (with weighting factors λ₁ and λ₂) of the overall distortion and frame distortion differences, e.g., formulated as follows:

$$D ( \{ {C}_{n}^{v , k} \} ) + {λ}_{1} \cdot Δ {D}_{1} ( \{ {C}_{n}^{v , k} \} ) + {λ}_{2} \cdot Δ {D}_{2} ( \{ {C}_{n}^{v , k} \} ) \qquad ( 19 )$$

Based on the above-outlined additional considerations, the problem of optimizing the overall distortion can be reformulated as Problem A2 presented below.

Problem A2 - Joint Overall Distortion and Temporal Consistency

```
  $arg {min}_{\{ {C}_{n}^{v , k} \}} D ( \{ {C}_{n}^{v , k} \} ) + {λ}_{1} \cdot Δ {D}_{1} ( \{ {C}_{n}^{v , k} \} ) + {λ}_{2} \cdot Δ {D}_{2} ( \{ {C}_{n}^{v , k} \} )$
Subject to
(A. 1) intra-view priority constraint
  For v ∈ {0, 1, ... , Nᵥ − 1} and j ∈ {0, 1, ... , G^{v} − 2}
  ${P}_{n}^{v , π ( {t}_{v} - j , {G}^{v} )} ( {C}_{n}^{v , π ( {t}_{v} - j , {G}^{v} )} ) \geq {P}_{n}^{v , π ( {t}_{v} - j - 1 , {G}^{v} )} ( {C}_{n}^{v , π ( {t}_{v} - j - 1 , {G}^{v} )} )$
(A. 2) inter-view priority constraint
  For v ∈ {0, 1, ... , Nᵥ − 2} and j ∈ {0, 1, ... , min(G^{v}, G^{v+1}) − 1}
  ${P}_{n}^{v , π ( {t}_{v} - j , {G}^{v} )} ( {C}_{n}^{v , π ( {t}_{v} - j , {G}^{v} )} ) \geq {P}_{n}^{v + 1 , π ( {t}_{v + 1} - j , {G}^{v + 1} )} ( {C}_{n}^{v + 1 , π ( {t}_{v + 1} - j , {G}^{v + 1} )} )$
(A. 3) bandwidth constraint
  ${\sum }_{v = 0}^{{N}_{v} - 1} {\sum }_{k = 0}^{{G}^{v} - 1} ( {S}_{n}^{v , k} + {C}_{n}^{v , k} ) \leq {N}_{n}$
```

In some examples, a solution to Problem A2 is similar to that provided by Algorithm A1 but with pertinent modifications. One modification is to compute the difference cost function for each (v, k) during the evaluation of the cost. The corresponding algorithm, denoted as Algorithm A2, is illustrated using the following example pseudocode.

Algorithm A2

```
$Set all {C}_{n}^{v , k} = 0 for all valid ( v , k ) . // initialize all assignment to 0$
$While {\sum }_{v = 0}^{{N}_{v} - 1} {\sum }_{k = 0}^{{G}^{v} - 1} ( {S}_{n}^{v , k} + {C}_{n}^{v , k} ) \leq {N}_{n} // until no packet to assign$
  Ω = {} // reset valid list to empty set
  for each (v, k) // test (v, k)
    // copy all parity packet assignment to a temp space
    ${C}_{n}^{′ v , k} = {C}_{n}^{v , k} for all ( v , k )$
    // assign one parity packet
    ${C}_{n}^{′ v , k} = {C}_{n}^{v , k} + 1$
    $if \{ {C}_{n}^{′ v , k} \} meets constraint ( A . 1 ) and ( A . 2 )$
      // compute cost
      $D ( \{ {C}_{n}^{v , k} \} ) + {λ}_{1} \cdot Δ {D}_{1} ( \{ {C}_{n}^{v , k} \} ) + {λ}_{2} \cdot Δ {D}_{2} ( \{ {C}_{n}^{v , k} \} )$
      // add (v, k) to valid list
      Ω = Ω ∪ (v, k)
    end
  end
  // select the (v, k) in Ω having the minimal cost
  $( {v}^{*} , {k}^{*} ) = arg {min}_{\{ ( v , k ) ∈ Ω \}} D ( \{ {C}_{n}^{v , k} \} ) + {λ}_{1} \cdot Δ {D}_{1} ( \{ {C}_{n}^{v , k} \} ) + {λ}_{2} \cdot Δ {D}_{2} ( \{ {C}_{n}^{v , k} \} )$
  // assign one parity packet to this (v, k)
  ${C}_{n}^{{v}^{*} , {k}^{*}} = {C}_{n}^{{v}^{*} , {k}^{*}} + 1$
end
```

The above-described optimization methods are configured to consider the expected received picture quality using unequal error protection. In some examples, it may also be beneficial to provide a “backup” plan (including suitable remedial actions) when the pertinent DU is actually lost due to the lossy channel. Such remedial actions may be based on one or more error concealment methods designed to handle the lost packets. One relatively straightforward approach to error concealment is to copy the previous frame/DU into current spatially co-located areas. This error concealment method works well for a static scene, such as video conferencing, but may be insufficient when applied to dynamic scenes, such as those related to sports. For such cases, an example embodiment may be configured to use a downsampled version of content as a new tile (in the corresponding DU). In some examples, this set of DU NALUs is afforded a strongest FEC protection.

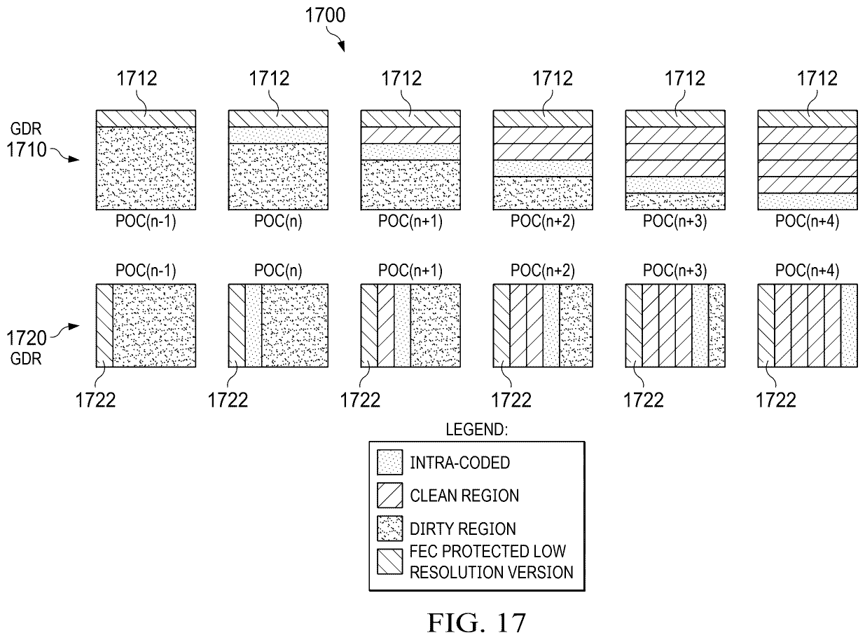

FIG. 17 is a schematic diagram illustrating two configurations (1710, 1720) of GDR according to some additional examples. The GDR configurations (1710, 1720) are best understood in comparison with the GDR configurations (810, 820) described above in reference to FIG. 8. More specifically, compared to the GDR configurations (810, 820), the GDR configurations (1710, 1720) use an extra (sixth) tile (1712, 1722) configured to carry a downsampled version of the content. The extra tile (1712, 1722) provides support for the error concealment method that invokes the downsampled version of content when a packet carrying a DU of the corresponding picture is lost in the channel.

In the example shown, the extra tile (1712, 1722) is carried by an additional DU placed at the beginning of the respective frame, i.e., by the first DU in the frame. Although other placements of the additional DU can also be used, this particular placement may be beneficial as it tends to provide a lowest end-to-end delay among possible options. As already mentioned above, this DU includes a spatially downsampled version of the current frame. In some examples, padded zeros can be used to conform the corresponding slice/tile to the video stream. Typically, the bit rate for the additional DU is relatively small.

The original main and side views will be still encoded using GDR as previously explained, with the application of unequal error protection. When a DU of the original main or side view is lost, the decoder will operate to select the corresponding area in the downsampled version and upsample it to replace the lost portion of the picture.

Let us denote the above-indicated additional downsampled DU as

$${U}_{n}^{v , - 1} .$$

the probability of successful decoding for this DU with the number of source packets

$${S}_{n}^{v , - 1} .$$

and the number of parity packets

$${C}_{n}^{v , - 1} is {P}_{n}^{′ v , - 1} ( {C}_{n}^{v , - 1} ) .$$

The distortion for using the upsampled version from the k-th corresponding DU is denoted as

$${D}_{n}^{v , ( - 1 \to k )} .$$

The expected distortion for the (v, k) DU may be considered to include two parts. A first part is to use the current successfully decoded DU to display if that DU is successfully decoded. The second part is if the current DU fails to decode, in which case the corresponding areas in the downsampled DU are used to decode and scale back to the intended resolution. The corresponding mathematical expression is as follows:

$${P}_{n}^{′ v , k} ( {C}_{n}^{v , k} ) \cdot {D}_{n}^{v , k} + {P}_{n}^{′ v , - 1} ( {C}_{n}^{v , - 1} ) ( 1 - {P}_{n}^{′ v , k} ( {C}_{n}^{v , k} ) ) \cdot {D}_{n}^{v , ( - 1 \to k )} \qquad ( 20 )$$

The corresponding objective function needs to address this new distortion associated with error concealment. The corresponding mathematical expression is as follows:

$$D ( \{ {C}_{n}^{v , k} \} , \{ {C}_{n}^{v , - 1} \} ) = {\sum }_{v = 0}^{{N}_{v} - 1} {\sum }_{k = 0}^{{G}^{v} - 1} {P}_{n}^{v , k} ( {C}_{n}^{v , k} ) \cdot {D}_{n}^{v , k} + {P}_{n}^{v , - 1} ( {C}_{n}^{v , - 1} ) ( 1 - {P}_{n}^{′ v , k} ( {C}_{n}^{v , k} ) ) \cdot {D}_{n}^{v , ( - 1 \to k )} \qquad ( 21 )$$

Note that

$$\{ {C}_{n}^{v , - 1} \}$$

also needs to be optimized. In some examples, the importance and priority of this downsampled version,

$${U}_{n}^{v , - 1} ,$$

is relatively the highest.

Based on the above-outlined additional considerations regarding the downsampled version of the frame, the problem of optimizing the overall distortion can be reformulated as Problem A3 presented below.

Problem A3 - With Downsampled Version

```
  $arg {min}_{\{ {C}_{n}^{v , k} \} , \{ {C}_{n}^{v , - 1} \}} D ( \{ {C}_{n}^{v , k} \} , \{ {C}_{n}^{v , - 1} \} )$
Subject to
(A. 1) intra-view priority constraint
  For v ∈ {0, 1, ... , Nᵥ − 1} and j ∈ {0, 1, ... , G^{v} − 2}
  ${P}_{n}^{v , - 1} ( {C}_{n}^{v , - 1} ) \geq {P}_{n}^{v , π ( {t}_{v} - j , {G}^{v} )} ( {C}_{n}^{v , π ( {t}_{v} - j , {G}^{v} )} ) \geq {P}_{n}^{v , π ( {t}_{v} - j - 1 , {G}^{v} )} ( {C}_{n}^{v , π ( {t}_{v} - j - 1 , {G}^{v} )} )$
(A. 2) inter-view priority constraint
  For v ∈ {0, 1, ... , Nᵥ − 2} and j ∈ {0, 1, ... , min(G^{v}, G^{v+1}) − 1}
  ${P}_{n}^{v , π ( {t}_{v} - j , {G}^{v} )} ( {C}_{n}^{v , π ( {t}_{v} - j , {G}^{v} )} ) \geq {P}_{n}^{v + 1 , π ( {t}_{v + 1} - j , {G}^{v + 1} )} ( {C}_{n}^{v + 1 , π ( {t}_{v + 1} - j , {G}^{v + 1} )} )$
(A. 3) bandwidth constraint (note k index starts from −1)
  ${\sum }_{v = 0}^{{N}_{v} - 1} {\sum }_{k = - 1}^{{G}^{v} - 1} ( {S}_{n}^{v , k} + {C}_{n}^{v , k} ) \leq {N}_{n}$
```

In some examples, a solution to Problem A3 is similar to that provided by Algorithm A1 but with pertinent modifications. The corresponding algorithm, denoted as Algorithm A3, is illustrated using the following example pseudocode.

Algorithm A3

```
// initialize all assignment to 0
$Set all {C}_{n}^{v , k} = 0 for all valid ( v , k ) , including k = - 1.$
$While {\sum }_{v = 0}^{{N}_{v} - 1} {\sum }_{k = 0}^{{G}^{v} - 1} ( {S}_{n}^{v , k} + {C}_{n}^{v , k} ) \leq {N}_{n} // until no packet to assign$
  Ω = {} // reset valid list to empty set
  for each (v, k) // test (v, k)
    // copy all parity packet assignment to a temp space
    ${C}_{n}^{′ v , k} = {C}_{n}^{v , k} for all ( v , k )$
    // assign one parity packet
    ${C}_{n}^{′ v , k} = {C}_{n}^{v , k} + 1$
    $if \{ {C}_{n}^{′ v , k} \} meets constraint ( A . 1 ) and ( A . 2 )$
      // compute cost
      $D ( \{ {C}_{n}^{v , k} \} , \{ {C}_{n}^{v , - 1} \} )$
      // add (v, k) to valid list
      Ω = Ω ∪ (v, k)
    end
  end
  // select the (v, k) in Ω having the minimal cost
  $( {v}^{*} , {k}^{*} ) = arg {min}_{\{ ( v , k ) ∈ Ω \}} D ( \{ {C}_{n}^{v , k} \} , \{ {C}_{n}^{v , - 1} \} )$
  // assign one parity packet to this (v, k)
  ${C}_{n}^{{v}^{*} , {k}^{*}} = {C}_{n}^{{v}^{*} , {k}^{*}} + 1$
end
```

The temporally consistent problem formulation corresponding to Problem A3 can be obtained based on the approach previously used for reformulating Problem A1 into Problem A2. A corresponding reformulated problem is Problem A4 presented below.

Problem A4 - Joint Overall Distortion and Temporal Consistency with
Downsampled version

```
  $arg {min}_{\{ {C}_{n}^{v , k} \}} D ( \{ {C}_{n}^{v , k} \} , \{ {C}_{n}^{v , - 1} \} ) + {λ}_{1} \cdot Δ {D}_{1} ( \{ {C}_{n}^{v , k} \} , \{ {C}_{n}^{v , - 1} \} ) + {λ}_{2} \cdot Δ {D}_{2} ( \{ {C}_{n}^{v , k} \} , \{ {C}_{n}^{v , - 1} \} )$
Subject to
(A. 1) intra-view priority constraint
  For v ∈ {0, 1, ... , Nᵥ − 1} and j ∈ {0, 1, ... , G^{v} − 2}
  ${P}_{n}^{v , - 1} ( {C}_{n}^{v , - 1} ) \geq {P}_{n}^{v , π ( {t}_{v} - j , {G}^{v} )} ( {C}_{n}^{v , π ( {t}_{v} - j , {G}^{v} )} ) \geq {P}_{n}^{v , π ( {t}_{v} - j - 1 , {G}^{v} )} ( {C}_{n}^{v , π ( {t}_{v} - j - 1 , {G}^{v} )} )$
(A. 2) inter-view priority constraint
  For v ∈ {0, 1, ... , Nᵥ − 2} and j ∈ {0, 1, ... , min(G^{v}, G^{v+1}) − 1}
  ${P}_{n}^{v , π ( {t}_{v} - j , {G}^{v} )} ( {C}_{n}^{v , π ( {t}_{v} - j , {G}^{v} )} ) \geq {P}_{n}^{v + 1 , π ( {t}_{v + 1} - j , {G}^{v + 1} )} ( {C}_{n}^{v + 1 , π ( {t}_{v + 1} - j , {G}^{v + 1} )} )$
(A. 3) bandwidth constraint (note k index starts from −1)
  ${\sum }_{v = 0}^{{N}_{v} - 1} {\sum }_{k = - 1}^{{G}^{v} - 1} ( {S}_{n}^{v , k} + {C}_{n}^{v , k} ) \leq {N}_{n}$
```

In some examples, a solution to Problem A4 is similar to that provided by Algorithm A4 but with pertinent modifications. The corresponding algorithm, denoted as Algorithm A4, is illustrated using the following example pseudocode.

Algorithm A4

```
// initialize all assignment to 0
$Set all {C}_{n}^{v , k} = 0 for all valid ( v , k ) , including k = - 1.$
$While {\sum }_{v = 0}^{{N}_{v} - 1} {\sum }_{k = 0}^{{G}^{v} - 1} ( {S}_{n}^{v , k} + {C}_{n}^{v , k} ) \leq {N}_{n} // until no packet to assign$
  Ω = {} // reset valid list to empty set
  for each (v, k) // test (v, k)
    // copy all parity packet assignment to a temp space
    ${C}_{n}^{′ v , k} = {C}_{n}^{v , k} for all ( v , k )$
    // assign one parity packet
    ${C}_{n}^{′ v , k} = {C}_{n}^{v , k} + 1$
    $if \{ {C}_{n}^{′ v , k} \} meets constraint ( A . 1 ) and ( A . 2 )$
      // compute cost
      $D ( \{ {C}_{n}^{v , k} \} , \{ {C}_{n}^{v , - 1} \} ) + {λ}_{1} \cdot Δ {D}_{1} ( \{ {C}_{n}^{v , k} \} , \{ {C}_{n}^{v , - 1} \} ) + {λ}_{2} \cdot Δ {D}_{2} ( \{ {C}_{n}^{v , k} \} , \{ {C}_{n}^{v , - 1} \} )$
      // add (v, k) to valid list
      Ω = Ω ∪ (v, k)
    end
  end
  // select the (v, k) in Ω having the minimal cost
  $( {v}^{*} , {k}^{*} ) = arg {min}_{\{ ( v , k ) ∈ Ω \}} D ( \{ {C}_{n}^{v , k} \} , \{ {C}_{n}^{v , - 1} \} )$
  // assign one parity packet to this (v, k)
  ${C}_{n}^{{v}^{*} , {k}^{*}} = {C}_{n}^{{v}^{*} , {k}^{*}} + 1$
end
```

### Example Hardware

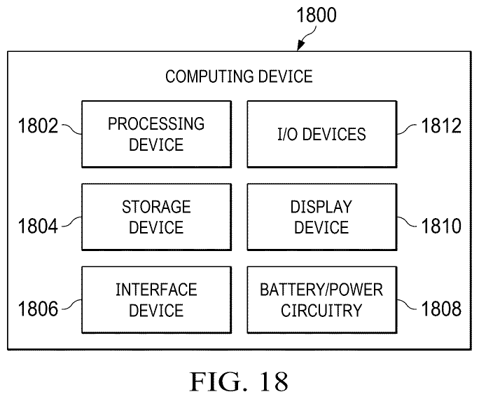

FIG. 18 is a block diagram of an example computing device (1800) configured to perform at least some operations of the above-described methods, algorithms, and procedures according to some examples. For example, in some embodiments, the computing device (1800) may perform at least some operations of the coding block (120) or the decoding block (130). In various embodiments, a node of the pertinent system may be implemented using a single computing device (1800) or using multiple computing devices (1800).

The computing device (1800) of FIG. 18 is illustrated as having a number of components, but any one or more of these components may be omitted or duplicated, as suitable for the application and setting. In some embodiments, some or all of the components included in the computing device (1800) may be attached to one or more motherboards and enclosed in a housing. In some embodiments, some of those components may be fabricated onto a single system-on-a-chip (SoC) (e.g., the SoC may include one or more processing devices (1802) and one or more storage devices (1804)). Additionally, in various embodiments, the computing device (1800) may not include one or more of the components illustrated in FIG. 18, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device (1800) may not include a display device (1810), but may include display device interface circuitry (e.g., a connector and driver circuitry) to which an external display device (1810) may be coupled.

The computing device (1800) includes a processing device (1802) (e.g., one or more processing devices). As used herein, the term “processing device” refers to any device or portion of a device that processes electronic data from registers and/or memory to transform that electronic data into other electronic data that may be stored in registers and/or memory. In various embodiments, the processing device (1802) may include one or more digital signal processors (DSPs), application-specific integrated circuits (ASICs), central processing units (CPUs), graphics processing units (GPUs), server processors, or any other suitable processing devices.

The computing device (1800) also includes a storage device (1804) (e.g., one or more storage devices). In various embodiments, the storage device (1804) may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device (1804) may include memory that shares a die with the processing device (1802). In such an embodiment, the memory may be used as cache memory and include embedded dynamic random-access memory (eDRAM) or spin transfer torque magnetic random-access memory (STT-MRAM), for example. In some embodiments, the storage device (1804) may include non-transitory computer readable media having instructions thereon that, when executed by one or more processing devices (e.g., the processing device (1802)), cause the computing device (1800) to perform any appropriate ones of the methods disclosed herein or portions of such methods.

The computing device (1800) further includes an interface device (1806) (e.g., one or more interface devices (1806)). In various embodiments, the interface device (1806) may include one or more communication chips, connectors, and/or other hardware and software to govern communications between the computing device (1800) and other computing devices. For example, the interface device (1806) may include circuitry for managing wireless communications for the transfer of data to and from the computing device (1800). The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 1806 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device (1806) for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device (1806) for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 1806 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device (1806) may include one or more antennas (e.g., one or more antenna arrays) configured to receive and/or transmit wireless signals.

In some embodiments, the interface device (1806) may include circuitry for managing wired communications, such as electrical, optical, or any other suitable communication protocols. For example, the interface device (1806) may include circuitry to support communications in accordance with Ethernet technologies. In some embodiments, the interface device (1806) may support both wireless and wired communication, and/or may support multiple wired communication protocols and/or multiple wireless communication protocols. For example, a first set of circuitry of the interface device (1806) may be dedicated to shorter-range wireless communications such as Wi-Fi or Bluetooth, and a second set of circuitry of the interface device (1806) may be dedicated to longer-range wireless communications such as global positioning system (GPS), EDGE, GPRS, CDMA, WiMAX, LTE, EV-DO, or others. In some other embodiments, a first set of circuitry of the interface device (1806) may be dedicated to wireless communications, and a second set of circuitry of the interface device (1806) may be dedicated to wired communications.

The computing device (1800) also includes battery/power circuitry (1808). In various embodiments, the battery/power circuitry (1808) may include one or more energy storage devices (e.g., batteries or capacitors) and/or circuitry for coupling components of the computing device (1800) to an energy source separate from the computing device (1800) (e.g., to AC line power).

The computing device (1800) also includes a display device (1810) (e.g., one or multiple individual display devices). In various embodiments, the display device (1810) may include any visual indicators, such as a heads-up display, a computer monitor, a projector, a touchscreen display, a liquid crystal display (LCD), a light-emitting diode display, or a flat panel display.

The computing device (1800) also includes additional input/output (I/O) devices (1812). In various embodiments, the I/O devices (1812) may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment, various components of the interface devices (1806) and/or I/O devices (1812) can be configured to output suitable signals, receive suitable signals, and receive and output data streams. In some examples, the interface devices (1806) and/or I/O devices (1812) include one or more analog-to-digital converters (ADCs) for transforming received analog signals into a digital form suitable for operations performed by the processing device (1802) and/or the storage device (1804). In some additional examples, the interface devices (1806) and/or I/O devices (1812) include one or more digital-to-analog converters (DACs) for transforming digital signals provided by the processing device (1802) and/or the storage device (1804) into an analog form suitable for being communicated over the corresponding communication channels.

### Example Workflows

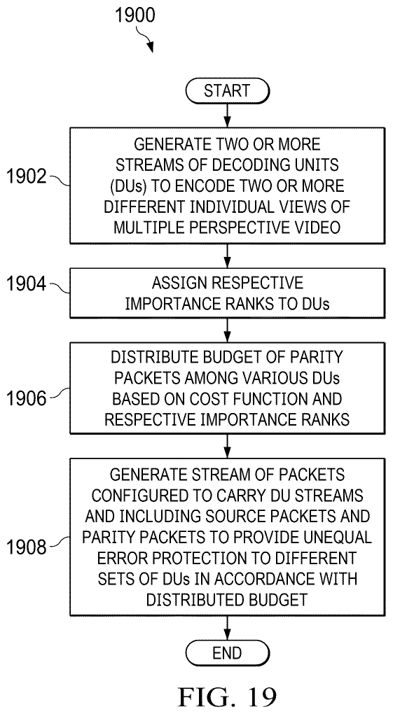

FIG. 19 is a flowchart illustrating a method (1900) of streaming a multiple perspective video according to some examples. The method (1900) may typically be implemented at the encoder side of the corresponding video-streaming system, such as a server of a multimedia content distribution system. In some examples, the method (1900) may be used in the coding block (120) of the video/audio/image delivery pipeline (100).

A block (1902) of the method (1900) includes generating two or more streams of decoding units (DUs) to encode two or more individual views of the multiple perspective video of a scene. For each of the DU streams, operations of the block (1902) typically include intra-coding a selected region of a respective frame, inter-coding other regions of the respective frame, and changing the selected region based on a respective GDR period.

In some examples, operations of the block (1902) include generating a first stream of DUs to encode a video of a first view of the scene by intra-coding a selected region of a respective frame, inter-coding other regions of the respective frame, and changing the selected region based on a first GDR period. Operations of the block (1902) further include generating a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view. In some examples, the second GDR period has a smaller number of frames than the first GDR period. In some additional examples, operations of the block (1902) further include generating a third stream of DUs to encode a video of a third view of the scene, with the video of the third view having a lower spatial resolution and a lower bit rate than the video of the second view.

In some examples, for a frame of the first view, the first stream of DUs includes a respective additional DU having encoded therein a downsampled version of the frame. In some additional examples, for a frame of the second view, the second stream of DUs includes a corresponding additional DU having encoded therein a downsampled version of that frame. In some examples, the additional DU is placed in a starting packet of a sequence of packets corresponding to the respective frame.

A block (1904) of the method (1900) includes assigning to each of the DUs generated in the block (1902) a respective importance rank. In some examples, the respective importance rank is determined based on one or more factors selected from the group consisting of: (i) whether the DU is intra-coded or inter-coded; (ii) relative importance of a corresponding view of the scene among a plurality of views of the multiple perspective video; and (iii) relative impact on video distortion of error propagation from the DU.

A block (1906) of the method (1900) includes distributing a budget of parity packets among the DUs based on a cost function. In some examples, the cost function is configured to approximately minimize expected distortion of the multiple perspective video at a player device connected to receive a stream of packets carrying the DU streams generated in the block (1902) through a communication channel. In a typical example, the budget is dynamically set in accordance with the fluctuating bandwidth of the communication channel. This means that a change in the bandwidth typically causes a corresponding change in the budget of parity packets.

In some examples, operations of the block (1906) include iteratively assigning portions of the budget to different ones of the DUs using a suitable greedy algorithm employing the cost function. In some examples, the cost function is further configured to constrain picture-quality inconsistency in temporally adjacent frames of a corresponding view of the scene in the multiple perspective video. In some examples, the picture-quality inconsistency includes a contribution from at least one of: (i) a picture quality inconsistency for a same DU location in the temporally adjacent frames, e.g., as illustrated in FIG. 16; and (ii) a picture quality inconsistency for intra-coded DUs in the temporally adjacent frames, e.g., as further illustrated in FIG. 16.

A block (1908) of the method (1900) includes generating a stream of packets to carry the DU streams generated in the block (1902). The stream of packets typically includes a stream of source packets and a stream of parity packets configured to provide unequal error protection to different sets of the DUs. The level of the unequal error protection afforded to an individual DU is based on the respective importance rank assigned in the block (1904). The unequal error protection is implemented using the budget of parity packets variously distributed in the block (1906).

In some examples, the unequal error protection is implemented using rateless forward error correction coding. In some examples, the rateless error correction code comprises a random linear network code (RLNC). In some examples, the rateless error correction code comprises a code selected from the group consisting of a Luby transform code, a Raptor code, a rateless fountain code, a rateless spinal code, and an RLNC.

In some examples, operations of the block (1908) further include generating one or more supplemental enhancement information (SEI) messages to signal one or more GDR parameters to a player device connected to receive the stream of packets.

In some examples, the first stream of DUs includes a first DU representing the selected region of the respective frame and second DU representing one of the other regions of the respective frame, and the stream of packets has a first number of parity packets corresponding to the first DU and a smaller second number of packets corresponding to the second DU. In some examples, the second stream of DUs includes a first DU representing the chosen region of the corresponding frame and second DU representing one of the other regions of the corresponding frame, and the stream of packets has a first number of parity packets corresponding to the first DU and a smaller second number of packets corresponding to the second DU. In some examples, the first stream of DUs includes a first DU representing the selected region of the respective frame, the second stream of DUs includes a second DU representing the chosen region of the corresponding frame, and the stream of packets has a first number of parity packets corresponding to the first DU and a smaller second number of packets corresponding to the second DU. In some examples, the first stream of DUs includes a first DU representing one of the other regions of the respective frame, the second stream of DUs includes a second DU representing the chosen region of the corresponding frame, and the stream of packets has a first number of parity packets corresponding to the first DU and a larger second number of packets corresponding to the second DU. In some examples, the stream of packets has zero parity packets corresponding to a DU representing one of the other regions of the respective frame or to a DU representing one of the other regions of the corresponding frame. Additional examples of the relative numbers of parity packets used with various source packets are illustrated in FIG. 15.

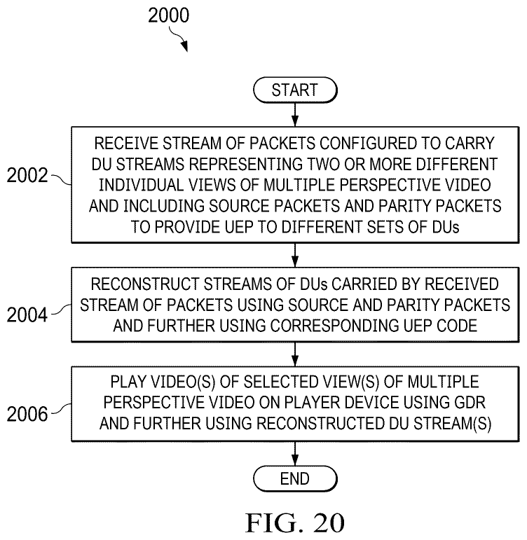

FIG. 20 is a flowchart illustrating a method (2000) of streaming a multiple perspective video according to some examples. The method (2000) may typically be implemented at the decoder side of the corresponding video-streaming system, such as a video player connected to a multimedia content distribution system. In some examples, the method (2000) may be used in the decoding block (130) of the video/audio/image delivery pipeline (100).

A block (2002) of the method (2000) includes receiving a stream of packets configured to carry DU streams representing two or more different individual views of a multiple perspective video and including source packets and parity packets to provide unequal error protection to different sets of DUs. In some examples, the received stream of packets carries a first stream of DUs and a second stream of DUs. The first stream of DUs encodes a video of a first view of the scene and is generated at the encoder side by intra-coding a selected region of a respective frame, inter-coding other regions of the respective frame, and changing the selected region based on a first GDR period. The second stream of DUs encodes a video of a second view of the scene and has been generated at the encoder side by intra-coding a chosen region of a corresponding frame, inter-coding other regions of the corresponding frame, and changing the chosen region based on a second GDR period. In some examples, the video of the second view has a lower spatial resolution and a lower bit rate than the video of the first view.

In some examples, the second GDR period has a smaller number of frames than the first GDR period. In some examples, the stream of packets is further configured to carry a third stream of DUs encoding a video of a third view of the scene having a lower spatial resolution and a lower bit rate than the video of the second view. In some examples, a level of the unequal error protection afforded to a DU is based on a respective importance rank assigned to the DU at the corresponding video encoder. In some examples, the respective importance rank is based on one or more factors selected from the group consisting of: (i) whether the DU is intra-coded or inter-coded; (ii) relative importance of a corresponding view of the scene among a plurality of views of the multiple perspective video; and (iii) relative impact on video distortion of error propagation from the DU.

In some examples, a ratio of the source to parity packets in a GDR period follows changes in the bandwidth of the communication channel through which the stream of packets is received. In some examples, for a frame of the first view, the first stream of DUs includes a respective additional DU having encoded therein a downsampled version of the frame. In some examples, for a frame of the second view, the second stream of DUs includes a corresponding additional DU having encoded therein a downsampled version of that frame.

In some examples, operations of the block (2002) also include receiving one or more supplemental enhancement information (SEI) messages configured to signal one or more GDR parameters to the player device.

A block (2004) of the method (2000) includes reconstructing the streams of DUs carried by the received stream of packets using the source and parity packets and further using the corresponding UEP code. In some examples, the unequal error protection is implemented using rateless forward error correction coding. In some examples, the rateless error correction code comprises a random linear network code (RLNC). In some examples, the rateless error correction code comprises a code selected from the group consisting of a Luby transform code, a Raptor code, a rateless fountain code, a rateless spinal code, and an RLNC.

A block (2006) of the method (2000) includes playing the video(s) of at least one selected view of the multiple perspective video on the player device using GDR and further using the corresponding one or more of the DU streams reconstructed in the block (2004). In some examples, operations of the block (2006) include replacing a picture portion corresponding to an undecodable or lost DU by a corresponding picture portion obtained using the downsampled version of the frame.

According to an example embodiment disclosed above, e.g., in the summary section and/or in reference to any one or any combination of some or all of FIGS. 1-20, provided is an apparatus for streaming a multiple perspective video of a scene, the apparatus comprising: at least one processor; and at least one memory including program code, wherein the at least one memory and the program code are configured to, with the at least one processor, cause the apparatus at least to: generate a first stream of decoding units (DUs) to encode a video of a first view of the scene by intra-coding a selected region of a respective frame, inter-coding other regions of the respective frame, and changing the selected region based on a first gradual decoding refresh (GDR) period; generate a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view; and generate a stream of packets to carry the first and second streams of DUs, the stream of packets including a stream of source packets and a stream of parity packets configured to provide unequal error protection to different sets of the DUs.

According to another example embodiment disclosed above, e.g., in the summary section and/or in reference to any one or any combination of some or all of FIGS. 1-20, provided is a method of streaming a multiple perspective video of a scene, the method comprising: generating a first stream of decoding units (DUs) to encode a video of a first view of the scene by intra-coding a selected region of a respective frame, inter-coding other regions of the respective frame, and changing the selected region based on a first gradual decoding refresh (GDR) period; generating a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view; and generating a stream of packets to carry the first and second streams of DUs, the stream of packets including a stream of source packets and a stream of parity packets configured to provide unequal error protection to different sets of the DUs.

In some embodiments of the above method, the first stream of DUs includes a first DU representing the selected region of the respective frame and second DU representing one of the other regions of the respective frame; and wherein the stream of packets has a first number of parity packets corresponding to the first DU and a smaller second number of packets corresponding to the second DU.

In some embodiments of any of the above methods, the second stream of DUs includes a first DU representing the chosen region of the corresponding frame and second DU representing one of the other regions of the corresponding frame; and wherein the stream of packets has a first number of parity packets corresponding to the first DU and a smaller second number of packets corresponding to the second DU.

In some embodiments of any of the above methods, the first stream of DUs includes a first DU representing the selected region of the respective frame; wherein the second stream of DUs includes a second DU representing the chosen region of the corresponding frame; and wherein the stream of packets has a first number of parity packets corresponding to the first DU and a smaller second number of packets corresponding to the second DU.

In some embodiments of any of the above methods, the first stream of DUs includes a first DU representing one of the other regions of the respective frame; wherein the second stream of DUs includes a second DU representing the chosen region of the corresponding frame; and wherein the stream of packets has a first number of parity packets corresponding to the first DU and a larger second number of packets corresponding to the second DU.

In some embodiments of any of the above methods, the stream of packets has zero parity packets corresponding to a DU representing one of the other regions of the respective frame or to a DU representing one of the other regions of the corresponding frame.

In some embodiments of any of the above methods, the second GDR period has a smaller number of frames than the first GDR period.

In some embodiments of any of the above methods, the method further comprises generating a third stream of DUs to encode a video of a third view of the scene, the video of the third view having a lower spatial resolution and a lower bit rate than the video of the second view, wherein the stream of packets is further configured to carry the third stream of DUs.

In some embodiments of any of the above methods, the method further comprises assigning to each of the DUs a respective importance rank, wherein a level of the unequal error protection afforded to a DU is based on the respective importance rank.

In some embodiments of any of the above methods, the respective importance rank is determined based on one or more factors selected from the group consisting of: whether the DU is intra-coded or inter-coded; relative importance of a corresponding view of the scene among a plurality of views of the multiple perspective video; and relative impact on video distortion of error propagation from the DU.

In some embodiments of any of the above methods, the method further comprises distributing a budget of parity packets among the DUs based on a cost function configured to substantially minimize expected distortion of the multiple perspective video at a player device connected to receive the stream of packets through a communication channel, the budget being set in accordance with a bandwidth of the communication channel.

In some embodiments of any of the above methods, a change in the bandwidth causes a corresponding change in the budget.

In some embodiments of any of the above methods, the distributing comprises iteratively assigning portions of the budget to different ones of the DUs using a greedy algorithm employing the cost function.

In some embodiments of any of the above methods, the cost function is further configured to constrain picture quality inconsistency in temporally adjacent frames of a view of the scene in the multiple perspective video.

In some embodiments of any of the above methods, the picture quality inconsistency includes a contribution of at least one of: a picture quality inconsistency for a same DU location in the temporally adjacent frames; and a picture quality inconsistency for intra-coded DUs in the temporally adjacent frames.

In some embodiments of any of the above methods, the distributing comprises iteratively assigning portions of the budget to different ones of the DUs using a greedy algorithm employing the cost function.

In some embodiments of any of the above methods, an iteration of the greedy algorithm comprises: computing a respective parity packet cost for each unassigned DU using the cost function; and selecting one of the unassigned DUs having a minimum cost among the computed respective parity packet costs for being assigned to a next parity packet from the budget of parity packets.

In some embodiments of any of the above methods, the selecting is subject to an intra-view priority constraint and an inter-view priority constraint.

In some embodiments of any of the above methods, the cost function includes a weighted sum of cost components; and wherein the cost components are selected from the group consisting of: an overall expected distortion component

$$( e . g . , D ( \{ {C}_{n}^{v , k} \} ) ) ;$$

a first temporal domain quality consistency component

$$( e . g . , Δ {D}_{1} ( \{ {C}_{n}^{v , k} \} ) ) ;$$

and a second temporal domain quality consistency component

$$( e . g . , Δ {D}_{2} ( \{ {C}_{n}^{v , k} \} ) ) .$$

In some embodiments of any of the above methods, at least one of the first and second streams of DUs includes a set of DUs in which each DU has encoded therein a downsampled version of a corresponding frame; and wherein the selecting is performed with consideration of said set of DUs.

In some embodiments of any of the above methods, for a frame of the first view, the first stream of DUs includes a respective additional DU having encoded therein a downsampled version of the frame.

In some embodiments of any of the above methods, for a frame of the second view, the second stream of DUs includes a corresponding additional DU having encoded therein a downsampled version of said frame.

In some embodiments of any of the above methods, the additional DU is placed in a starting packet of a sequence of packets corresponding to the respective frame.

In some embodiments of any of the above methods, the additional DU is afforded a relatively highest level of the unequal error protection among a plurality of DUs of the respective frame.

In some embodiments of any of the above methods, the unequal error protection is implemented using rateless forward error correction coding (e.g., using random linear network coding, RLNC).

In some embodiments of any of the above methods, the method further comprises generating one or more supplemental enhancement information (SEI) messages to signal one or more GDR parameters to a player device connected to receive the stream of packets.

Some embodiments provide a non-transitory computer-readable medium storing instructions that, when executed by an electronic processor, cause the electronic processor to perform operations comprising any one of the above methods.

According to yet another example embodiment disclosed above, e.g., in the summary section and/or in reference to any one or any combination of some or all of FIGS. 1-20, provided is an apparatus for streaming a multiple perspective video of a scene, the apparatus comprising: at least one processor; and at least one memory including program code, wherein the at least one memory and the program code are configured to, with the at least one processor, cause the apparatus at least to: receive a stream of packets configured to carry a first stream of decoding units (DUs) and a second stream of DUs, the stream of packets including a stream of source packets and a stream of parity packets configured to provide unequal error protection to different sets of the DUs, the first stream of DUs encoding a video of a first view of the scene and having been generated by intra-coding a selected region of a respective frame, inter-coding other regions of the respective frame, and changing the selected region based on a first gradual decoding refresh (GDR) period, the second stream of DUs encoding a video of a second view of the scene and having been generated by intra-coding a chosen region of a corresponding frame, inter-coding other regions of the corresponding frame, and changing the chosen region based on a second GDR period, the video of the second view having a lower spatial resolution and a lower bit rate than the video of the first view; reconstruct the first stream of DUs and the second stream of DUs based on the stream of source packets and the stream of parity packets; and play at least one of the video of the first view and the video of the second view on a player device using GDR and further using at least one of the reconstructed first and second streams of DUs.

According to yet another example embodiment disclosed above, e.g., in the summary section and/or in reference to any one or any combination of some or all of FIGS. 1-20, provided is a method of streaming a multiple perspective video of a scene, the method comprising: receiving a stream of packets configured to carry a first stream of decoding units (DUs) and a second stream of DUs, the stream of packets including a stream of source packets and a stream of parity packets configured to provide unequal error protection to different sets of the DUs, the first stream of DUs encoding a video of a first view of the scene and having been generated by intra-coding a selected region of a respective frame, inter-coding other regions of the respective frame, and changing the selected region based on a first gradual decoding refresh (GDR) period, the second stream of DUs encoding a video of a second view of the scene and having been generated by intra-coding a chosen region of a corresponding frame, inter-coding other regions of the corresponding frame, and changing the chosen region based on a second GDR period, the video of the second view having a lower spatial resolution and a lower bit rate than the video of the first view; reconstructing the first stream of DUs and the second stream of DUs based on the stream of source packets and the stream of parity packets; and playing at least one of the video of the first view and the video of the second view on a player device using GDR and further using at least one of the reconstructed first and second streams of DUs.

In some embodiments of the above method, the second GDR period has a smaller number of frames than the first GDR period.

In some embodiments of any of the above methods, the stream of packets is further configured to carry a third stream of DUs encoding a video of a third view of the scene having a lower spatial resolution and a lower bit rate than the video of the second view.

In some embodiments of any of the above methods, a level of the unequal error protection afforded to a DU is based on a respective importance rank assigned to the DU at a corresponding video encoder.

In some embodiments of any of the above methods, the respective importance rank is based on one or more factors selected from the group consisting of: whether the DU is intra-coded or inter-coded; relative importance of a corresponding view of the scene among a plurality of views of the multiple perspective video; and relative impact on video distortion of error propagation from the DU.

In some embodiments of any of the above methods, a ratio of the source to parity packets in a GDR period changes with a change in a bandwidth of a communication channel through which the stream of packets is received.

In some embodiments of any of the above methods, for a frame of the first view, the first stream of DUs includes a respective additional DU having encoded therein a downsampled version of the frame.

In some embodiments of any of the above methods, for a frame of the second view, the second stream of DUs includes a corresponding additional DU having encoded therein a downsampled version of said frame.

In some embodiments of any of the above methods, the method further comprises replacing a picture portion corresponding to an undecodable DU by a corresponding picture portion obtained using the downsampled version.

In some embodiments of any of the above methods, the unequal error protection is implemented using rateless forward error correction coding.

In some embodiments of any of the above methods, the method further comprises receiving one or more supplemental enhancement information (SEI) messages configured to signal one or more GDR parameters to the player device.

Some embodiments provide a non-transitory computer-readable medium storing instructions that, when executed by an electronic processor, cause the electronic processor to perform operations comprising the any one of the above methods.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. A method of streaming a multiple perspective video of a scene, the method comprising:
generating a first stream of decoding units (DUs) to encode a video of a first view of the scene by intra-coding a selected region of a respective frame, inter-coding other regions of the respective frame, and changing the selected region based on a first gradual decoding refresh (GDR) period;
generating a second stream of DUs to encode a video of a second view of the scene by intra-coding a chosen region of a corresponding frame, inter-coding other regions of the corresponding frame, and changing the chosen region based on a second GDR period, the video of the second view having a lower spatial resolution and a lower bit rate than the video of the first view; and
generating a stream of packets to carry the first and second streams of DUs, the stream of packets including a stream of source packets and a stream of parity packets configured to provide unequal error protection to different sets of the DUs.

2. The method of claim 1, further comprising generating a third stream of DUs to encode a video of a third view of the scene, the video of the third view having a lower spatial resolution and a lower bit rate than the video of the second view,
wherein the stream of packets is further configured to carry the third stream of DUs.

3. The method of claim 1, further comprising assigning to each of the DUs a respective importance rank,
wherein a level of the unequal error protection afforded to a DU is based on the respective importance rank.

4. The method of claim 3, wherein the respective importance rank is determined based on one or more factors selected from the group consisting of:
whether the DU is intra-coded or inter-coded;
relative importance of a corresponding view of the scene among a plurality of views of the multiple perspective video; and
relative impact on video distortion of error propagation from the DU.

5. The method of claim 1, further comprising distributing a budget of parity packets among the DUs based on a cost function configured to substantially minimize expected distortion of the multiple perspective video at a player device connected to receive the stream of packets through a communication channel, the budget being set in accordance with a bandwidth of the communication channel.

6. The method of claim 5,
wherein a change in the bandwidth causes a corresponding change in the budget; and
wherein the distributing comprises iteratively assigning portions of the budget to different ones of the DUs using a greedy algorithm employing the cost function.

7. The method of claim 5, wherein the cost function is further configured to constrain picture quality inconsistency in temporally adjacent frames of a view of the scene in the multiple perspective video.

8. The method of claim 7, wherein the picture quality inconsistency includes a contribution of at least one of:
a picture quality inconsistency for a same DU location in the temporally adjacent frames; and
a picture quality inconsistency for intra-coded DUs in the temporally adjacent frames.

9. The method of claim 5, wherein the distributing comprises iteratively assigning portions of the budget to different ones of the DUs using a greedy algorithm employing the cost function.

10. The method of claim 9, wherein an iteration of the greedy algorithm comprises:
computing a respective parity packet cost for each unassigned DU using the cost function;
selecting one of the unassigned DUs having a minimum cost among the computed respective parity packet costs for being assigned to a next parity packet from the budget of parity packets; and
wherein the selecting is subject to an intra-view priority constraint and an inter-view priority constraint.

11. The method of claim 10,
wherein the cost function includes a weighted sum of cost components, and
wherein the cost components are selected from the group consisting of:
an overall expected distortion component
$$( e . g . , D ( \{ {C}_{n}^{v , k} \} ) ) ;$$
a first temporal domain quality consistency component
$$( e . g . , Δ {D}_{1} ( \{ {C}_{n}^{v , k} \} ) ) ;$$
and
a second temporal domain quality consistency component
$$( e . g . , Δ {D}_{2} ( \{ {C}_{n}^{v , k} \} ) ) .$$

12. The method of claim 10,
wherein at least one of the first and second streams of DUs includes a set of DUs in which each DU has encoded therein a downsampled version of a corresponding frame; and
wherein the selecting is performed with consideration of said set of DUs.

13. The method of claim 1,
wherein, for a frame of the first view, the first stream of DUs includes a respective additional DU having encoded therein a downsampled version of the frame;
wherein, for a frame of the second view, the second stream of DUs includes a corresponding additional DU having encoded therein a downsampled version of said frame;
wherein the additional DU is placed in a starting packet of a sequence of packets corresponding to the respective frame; and
wherein the additional DU is afforded a relatively highest level of the error protection among a plurality of DUs of the respective frame.

14. The method of claim 1, wherein the unequal error protection is implemented using rateless forward error correction coding.

15. The method of claim 1, further comprising generating one or more supplemental enhancement information (SEI) messages to signal one or more GDR parameters to a player device connected to receive the stream of packets.

16. A method of streaming a multiple perspective video of a scene, the method comprising:
receiving a stream of packets configured to carry a first stream of decoding units (DUs) and a second stream of DUs, the stream of packets including a stream of source packets and a stream of parity packets configured to provide unequal error protection to different sets of the DUs, the first stream of DUs encoding a video of a first view of the scene and having been generated by intra-coding a selected region of a respective frame, inter-coding other regions of the respective frame, and changing the selected region based on a first gradual decoding refresh (GDR) period, the second stream of DUs encoding a video of a second view of the scene and having been generated by intra-coding a chosen region of a corresponding frame, inter-coding other regions of the corresponding frame, and changing the chosen region based on a second GDR period, the video of the second view having a lower spatial resolution and a lower bit rate than the video of the first view;
reconstructing the first stream of DUs and the second stream of DUs based on the stream of source packets and the stream of parity packets; and
playing at least one of the video of the first view and the video of the second view on a player device using GDR and further using at least one of the reconstructed first and second streams of DUs.

17. The method of claim 16, the rateless error correction code comprises a code selected from the group consisting of:
a Luby transform code,
a Raptor code,
a rateless fountain code,
a rateless spinal code, and
a random linear network code.

18. A non-transitory computer-readable medium storing instructions that, when executed by an electronic processor, cause the electronic processor to perform operations comprising the method of claim 1.
